(19) United States
(12) Patent Application Publication
(10) Pub. No.: US 2021/0342490 A1
(43) Pub. Date: Nov. 4, 2021

(54) AUDITABLE SECURE REVERSE ENGINEERING PROOF MACHINE LEARNING PIPELINE AND METHODS

(71) Applicant: Cerebri AI Inc., Austin, TX (US)

(72) Inventors: Alain Charles Briancon, Germantown, MD (US); Eric Paver Simon, Denver, CO (US); Mirza Safiullah Baig, Hamilton (CA); Jean Joseph Belanger, Austin, TX (US); Michael Henry Engeling, Austin, TX (US); Sathish Kumar Lakshmipathy, Round Rock, TX (US); Travis Stanton Penn, Austin, TX (US); Bryan Wayne Collins, North Bay (CA); Arun Prakash, Austin, TX (US); Chris Michael Coovrey, Austin, TX (US); Piyush Sunil Deshmukh, Austin, TX (US); Vasilis Andrew Sotiris, College Park, MD (US); Mounib Mohamad Ismail, Toronto (CA)

(21) Appl. No.: 17/307,646

(22) Filed: May 4, 2021

Related U.S. Application Data
(60) Provisional application No. 63/019,803, filed on May 4, 2020.

(51) Int. Cl. G06F 21/75; G06N 20/00; G06N 5/04

(52) U.S. Cl. CPC G06F 21/75; G06N 5/04; G06N 20/00

(57) ABSTRACT

Provided is a process including: searching code of a machine-learning pipeline to find a first and a second object code sequences performing similar tasks; modifying the code of the machine learning pipeline by inserting a third object code sequence into the code of the machine learning pipeline, the third code sequence being operable to pass control to the first object code sequence; inserting a branch at the end of the first code sequence, the branch being operable to: pass control, upon detection of a first predefined condition, to an instruction following the first object code sequence, and to pass control, upon detection of a second predefined condition, to an instruction following the third object code sequence; and wherein the third code sequence is executed in place of the second object sequence without affecting completion of the tasks.

### CROSS-REFERENCE TO RELATED APPLICATIONS

This patent filing claims the benefit of U.S. Non-Provisional Patent Application 63/019,803, titled AUDITABLE SECURE REVERSE ENGINEERING PROOF MACHINE LEARNING PIPELINE AND METHODS, filed 4 May 2021. The entire content of each aforementioned, earlier-filed patent filing is hereby incorporated by reference.

### BACKGROUND

### 1. Field

The present disclosure generally relates to machine learning and other forms of artificial intelligence and, more specifically, to protecting data and designs in the form of models or pipelines from reverse engineering.

### 2. Description of the Related Art

Advanced machine learning is becoming essential for many businesses. To address this need, many companies complement their internal development effort with third-party, machine-learning packages and other systems. Machine learning systems can be exceedingly complex and costly to develop. Because of the nature of the development of machine learning, especially for validation, this opens the door for abuse. As a result, machine-learning companies often desire to protect their algorithms, ETL (extract, transform, and load) methods, data structures, software implementations, and pipelines from reverse-engineering by competitors, from copying by internal customer teams (e.g., those using such libraries or frameworks), or from tampering by persons attempting to undermine the integrity of the software's operation.

### SUMMARY

The following is a non-exhaustive listing of some aspects of the present techniques. These and other aspects are described in the following disclosure.

Some aspects include a process, including: searching for a code representation of a machine learning pipeline to find a first and a second object code sequences, the first and the second object code sequences performing similar tasks; modifying the code representation of the machine learning pipeline by inserting a third object code sequence into the code representation of the machine learning pipeline, the third code sequence comprising one or more instructions, and being operable to pass control to the first object code sequence; inserting a branch at the end of the first code sequence, the branch being operable to: pass control, upon detection of a first predefined condition, to an instruction following the first object code sequence, and to pass control, upon detection of a second predefined condition, to an instruction following the third object code sequence; and wherein the third code sequence is executed in place of the second object sequence without affecting completion of the tasks.

Some aspects include a tangible, non-transitory, machine-readable medium storing instructions that when executed by a data processing apparatus cause the data processing apparatus to perform operations including the above-mentioned process.

Some aspects include a system, including: one or more processors; and memory storing instructions that when executed by the processors cause the processors to effectuate operations of the above-mentioned process.

### BRIEF DESCRIPTION OF THE DRAWINGS

The above-mentioned aspects and other aspects of the present techniques will be better understood when the present application is read in view of the following figures in which like numbers indicate similar or identical elements:

FIG. 1 illustrates an example of computing environments by which some embodiments of the present techniques may be implemented;

FIG. 2 illustrates an example of a machine-learning logical architecture upon which some embodiments of the present techniques may operate;

FIG. 3 illustrates an example of a machine-learning functional pipeline upon which some embodiments of the present techniques may operate;

FIG. 4 is a flowchart showing an example of a process by which an auditable, secure, reverse-engineering resistant machine learning pipeline may be created, in accordance with some embodiments;

FIG. 5 is a flow chart of an example process by which the present techniques may be implemented;

FIG. 6 is a flowchart illustrating an example of a process by which code or data implementing a machine learning model is modified in accordance with some embodiments of the present techniques;

FIG. 7 is another flowchart illustrating another example of a process by which code or data implementing a machine learning model is modified in accordance with some embodiments of the present techniques;

FIG. 8 is another flowchart illustrating another example of a process by which code or data implementing a machine learning model is modified in accordance with some embodiments of the present techniques;

FIG. 9 is another flowchart illustrating another example of a process by which code or data implementing a machine learning model is modified in accordance with some embodiments of the present techniques;

FIG. 10 is another flowchart illustrating another example of a process by which code or data implementing a machine learning model is modified in accordance with some embodiments of the present techniques;

FIG. 11 is another flowchart illustrating another example of a process by which code or data implementing a machine learning model is modified in accordance with some embodiments of the present techniques;

FIG. 12 is another flowchart illustrating another example of a process by which code or data implementing a machine learning model is modified in accordance with some embodiments of the present techniques; and

FIG. 13 illustrates an example of a computing device by which the present techniques may be implemented.

While the present techniques are susceptible to various modifications and alternative forms, specific embodiments thereof are shown by way of example in the drawings and will herein be described in detail. The drawings may not be to scale. It should be understood, however, that the drawings and detailed description thereto are not intended to limit the present techniques to the particular form disclosed, but to the contrary, the intention is to cover all modifications, equivalents, and alternatives falling within the spirit and scope of the present techniques as defined by the appended claims.

### DETAILED DESCRIPTION OF CERTAIN EMBODIMENTS

To mitigate the problems described herein, the inventors had to both invent solutions and, in some cases, just as importantly, recognize problems overlooked (or not yet foreseen) by others in the fields of computer science and data science. Indeed, the inventors wish to emphasize the difficulty of recognizing those problems that are nascent and will become much more apparent in the future should trend in the industry continue as the inventors expect. Further, because multiple problems are addressed, it should be understood that some embodiments are problem-specific, and not all embodiments address every problem with traditional systems described herein or provide every benefit described herein. That said, improvements that solve various permutations of these problems are described below.

While copyright law and patent law provide some level of protection against reverse-engineering of machine-learning systems, in many instances, these legal protections are insufficient. What is needed are technical methodologies for shielding the operational details of machine learning from the view of others or tracking attempts (successful or not) to reverse engineer or extract components of a machine-learning system.

Yet, due to the way machine learning software is often deployed, these are difficult tasks. For example, machine-learning software is at times installed on an enterprise consumer's cloud system or on a high-performance cluster, which is typically remote from the third-party developer's system and in an untrusted environment from the perspective of the developer. The enterprise consumer's cloud system may thus provide an environment in which an attacker can analyze and modify the software with relative ease and with little risk of detection. Accordingly, systems and methods are also needed for protecting the secrecy and integrity of machine-learning software when it is run in potentially untrusted or even hostile environments.

The foregoing should not, however, be treated as disclaiming any subject matter or as a requirement that all claimed embodiments entirely address these issues. Various inventive techniques are described, with various engineering and cost tradeoffs. Some embodiments may only address a subset of these issues or offer other advantages that will be self-evident to one of ordinary skill in the art with the benefit of this disclosure.

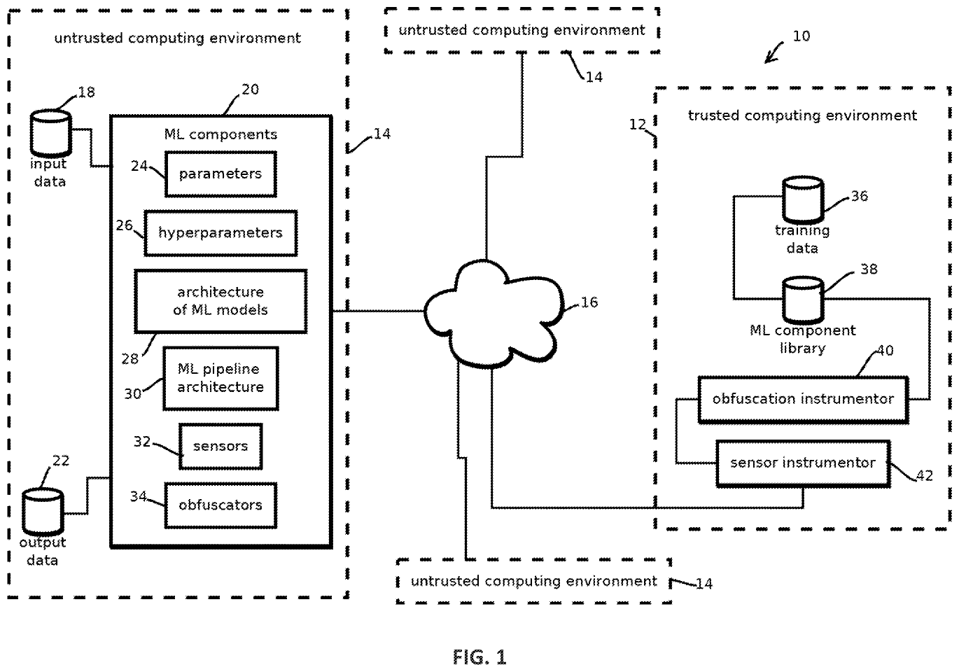

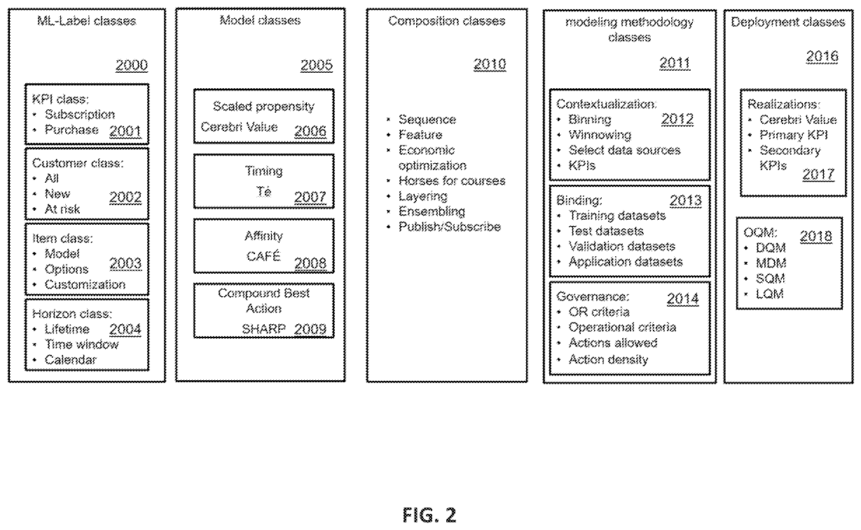

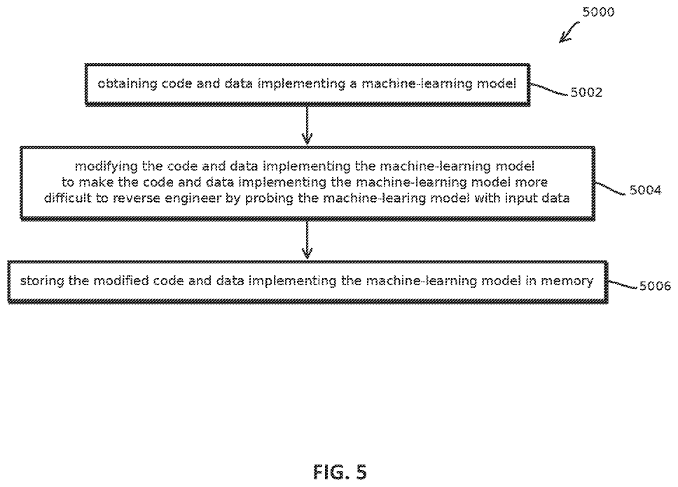

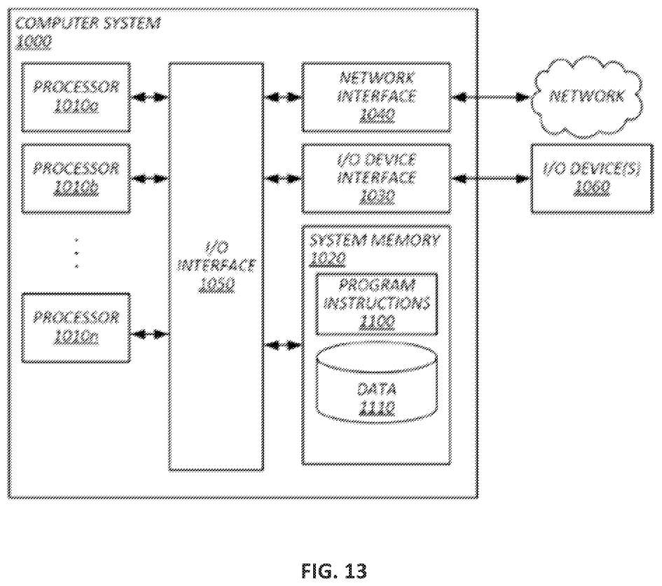

FIG. 1 shows an example of a system 10 in which machine-learning assets from a trusted computing environment 12 are provided to, and used within, un-trusted computing environments 14. The term “trust” here does not refer to a particular state of mind, but rather indicates that different networks or computing architectures controlled by different entities are used in the different environments 12 and 14, such that an entity operating the environment 12 does not have guarantees about how entities operating the environments 14 will use the machine-learning assets described. In some embodiments, the environments 12 and 14 correspond to different enterprise networks, cloud hosted accounts of different tenants in a cloud computing data center, virtual private networks, software defined networks, or the like. In some embodiments, the trusted computing environment 12 is operated by an entity that provides machine learning assets, like data for training, architectures in a library or framework of machine-learning models, or compilations of the foregoing, such as pipelined machine-learning architectures that are trained on the training data. These assets may be provided to other entities, such as customers of the entity operating the environment 12, that use the machine-learning assets, for instance, for various business purposes, examples of which are described below. In some embodiments, the machine-learning assets include features like those described below with reference to FIGS. 2 through 4, and these assets may be protected with techniques like those described below with reference to FIGS. 5 through 12, for instance, by executing code on computing devices like those described below with reference to FIG. 13.

In some embodiments, the system 10 includes a network 16, such as the Internet, over which the various geographically remote computing environments 12 and 14 communicate, for instance, to provide machine-learning assets from the computing environment 12 to the un-trusted computing environments 14. In some embodiments, information may be reported back from the computing environments 14 to the computing environment 12, for instance, to a server within the computing environment 12 exposing an application program interface by which such reports are logged and alarms are triggered, in some cases to alert technicians to abuse of machine-learning assets.

Three un-trusted computing environments 14 are shown, but commercial embodiments are expected to include substantially more, for instance, more than 5, or more than 50, corresponding to different customers of the entity operating the trusted computing environment 12. In some embodiments, the un-trusted computing environments 14 may include one or more sources of input data 18, an assemblage of machine-learning components 20, and output data repository 22. Examples of these components are described below with reference to FIGS. 2 through 4. In some embodiments, the machine-learning components 20 include model parameters 24 (such as weights and biases of neural networks or other parameters of other types of models like those described below), model hyperparameters 26, architectures of machine learning models 28 (such as directed acyclic graphs with transformer nodes, connection graphs of perceptrons in deep neural networks, arrangements of Bayesian classifiers in dynamic Bayesian networks, reinforcement learning policies, and the like, again with substantially more examples discussed below), and a machine learning pipeline architecture 30, such as a call graph of a collection of machine learning models or dataflow through a sequence (which may include branching components) of machine learning models, again examples of which are described below. In some embodiments, the machine-learning components 20 may include components added within the trusted computing environment 12 to protect the aforementioned components by deterring, making detectable, or impeding attempts to reverse engineer the foregoing components 20. In some embodiments, sensors 32 and obfuscators 34 may be added to the machine learning components 20 within the trusted computing environment 12 to such ends, for instance, with the techniques described below with reference to FIGS. 5 through 12, in the form of the described modifications to data and code. In some embodiments, the sensors 32 and the obfuscators 34 may be bodies of code added to the machine learning components or marked data, like watermarked or fingerprinted training or query time data, that produce signals in the output data 22 that are detectable from outside the un-trusted computing environment 14.

In some embodiments, the trusted computing environment 12 includes training data 36, a machine learning component library 38, an obfuscation instrumentor 40 and a sensor instrumentor 42. In some embodiments, the training data repository 36 and the machine-learning component library 38 may take the form of the components described below with reference to FIGS. 2 through 4, for example. In some embodiments, the obfuscation instrumentor 40 may add code (like element 34) to machine-learning components of the library 38 that protect them from reverse engineering attempts, and the sensor instrumentor 42 may create tagged or fingerprinted data (like sensors 32) to protect training data 36 or other forms of data operated upon by the components of the library 38. In some embodiments, different un-trusted computing environments 14 may draw different subsets of components of the library 38, for example, different machine-learning pipelines or components thereof, and in some cases some components may be shared across multiple un-trusted computing environments 14.

Some example machine-learning systems that may be protected with the present techniques generally relate to predictive computer models and, more specifically, to the creation and operation of numerous machine learning or other firms of AI (artificial intelligence) pipelines supporting multiple prediction models. Some embodiments are in a form that allows leveraging various data sources and multiple machine-learning models and repositories, even when these are widely different in scope, data set update rate, privacy, and operational governance.

Some embodiments create or otherwise obtain a customer journey in the form of an event timeline (or a plurality of event timelines) integrating the different events that impact or reflect the behavior of a customer. In some embodiments, these records may correspond to the customer journeys described in U.S. patent application Ser. No. 15/456,059, titled BUSINESS ARTIFICIAL INTELLIGENCE MANAGEMENT ENGINE, the contents of which are hereby incorporated by reference. Machine learning may be used to extract the appropriate patterns from such data. The models built and trained with the journey time series are may be used to score a step's (in the journey) performance posture in the form of a performance index. Performance might be a risk, a brand commitment, a social impact, an affinity to latent elements, a confounding tendency, performance quality, or engagement. Journeys may be encoded in memory as a set of time-stamped or otherwise sequenced entries in a record, each including an event and information about that event. The ability to assess the performance index (e.g., through threshold analysis, conformal mapping, etc.) is not limited to past and present events, in some embodiments, which is not to suggest that other described features are limiting. Still, it may also be used to predict the performance index for future events, in some embodiments. Future events can be associated with significant outcomes related to the form of performance of interest. For instance, purchases may be associated with brand affinity. Defaulting on a loan may be associated with risk. The power of such a design makes it a target-rich environment for reverse engineering or cutting and pasting into other pipelines.

At times, multiple performance indices are relevant for some embodiments. In some embodiments, models associated with different desired outcomes may be managed as a library (or a framework) of composable units and combined through a pipeline. Models may feed into one another. Model pre and post-processing may be intensive and the source of substantial intellectual property. The power of such pre-processing and post-processing may make them a target-rich environment for reverse engineering or cutting and pasting into other pipelines.

For reverse engineering of semiconductor components, power and injection probes have been used extensively. It is expected analogous non-intrusive methods will be mimicked in the field of AI. There is a salient difference between a static design of a semiconductor and an inherently dynamic machine learning pipeline. Machine Learning exists in the context of data, for training and scoring. As such, properly crafted data may be used to probe an otherwise confidential, black box (from the perspective of the party undertaking the probing) machine learning model or pipeline. Thoughtfully selected inputs may cause the model to produce outputs indicative of the model architecture, hyper-parameters, or parameter values, in some cases, even when the threat actor does not have access to a source-code representation of the model and the model, and when executed process uses address space layout randomization to impede attempts to inspect system memory by a threat actor with physical access. Example attacks are described by Tegjyot et al, in a paper titled “Data Driven Exploratory Attacks on Black Box Classifiers in Adversarial Domains,” published 23 Mar. 2017, indexed to address arXiv:1703.07909v1 by arxiv.org, a paper the contents of which are hereby incorporated by reference. There is, thus, a need to prevent the use of datasets to reverse engineer design.

In some embodiments, additional computationally-intensive operations are injected at one or more points in the processing pipeline over scheduled, dynamically determined, or random time periods. In some embodiments, additional requests for memory are injected at one or more points in the pipeline over scheduled, dynamically determined, or random time periods.

In some embodiments, the machine learning pipeline may apply quality-management techniques to assess if a dataset and/or transformations thereof input to the model by an untrusted entity is synthetic or manipulated to detect key features or the type of algorithms used. Those reverse engineering techniques could be amplifications of specific attributes to see if the output from the pipeline varies greatly with those attributes, changing the balance of positive and negative classes, changes in time scale etc. To prevent those, in some embodiments, the pipeline can stop operation upon detection of systematic imbalances in the data, e.g., upon determining that there is greater than a threshold likelihood that the input data is not identically and independently distributed (IID). In some embodiments, the pipeline may alter operation upon detection of systematic imbalances in the data. In some cases, the alterations are repeated over time to impede attempts to reverse engineer the model, by creating a moving target, while keeping the model's operation within the boundaries of performance guarantees (e.g., F1 scores, type 1 or type 2 error rates, latency limits, etc.) in some cases.

In some embodiments, the models are used to help specific business models, such as advertising, insurance, wealth management, lead generation, affiliate sale, classifieds, featured list, location-based offers, sponsorships, targeted offers, commerce, retailing, marketplace, crowd sourced marketplace, excess capacity markets, vertically integrated commerce, aggregator, flash sales, group buying, digital goods, sales goods, training, commission, commission per order, auction, reverse auction, opaque inventory, barter for services, pre-payment, subscription, brokering, donations, sampling, membership services, insurance, peer-to-peer service, transaction processing, merchant acquiring, intermediary, acquiring processing, bank transfer, bank depository offering, interchange fee per transaction, fulfillment, licensing, data, user data, user evaluations, business data, user intelligence, search data, real consumer intent data, benchmarking services, market research, push services, links to an app store, coupons, loyalty program, digital-to-physical, subscription, online education, crowdsourcing education, delivery, gift recommendation, coupons, loyalty programs, alerts, and coaching, recipe imports, ontology based searches, taxonomy based searches, location based searches, recipe management, curation, preparation time estimation, cooking time estimation, difficult estimation, meal planning, update to profiling, management of history, authorization for deep-linking, login in, signing up, login out, creating accounts, delete accounts, software driven modifications, database driven modifications based on allergens, inventory estimation based on superset approach, inventory estimation based on a priori and superset data, inventory estimation integrating direct queries, tracking of expenses, ordering, reservation, rating, deep linking, games, gamification, presentation of incentives, presentation of recommendations, internal analytics, external analytics, and single sign on with social networks.

As a result, the models may be used to predict the likelihood that, conditional on some input state, a desired or undesired outcome may happen, as well as plan actions (future steps) to decrease one or more performance indexes and thus improve continuous performance posture. In particular, the best (estimated, or better than some finite set of alternatives) possible next action (or set of actions) may be identified to meet a specific performance management objective in some embodiments.

The availability of actions and events on many time series, some of which lead to risk-related incidents, in some embodiments, may be used to train machine learning models to estimate a performance index at every step in an actual time series of actions and events. These models may then be used to predict (e.g., may execute the act of predicting) the likelihood of future incidents, thus providing a continuous assessment of continuous performance.

In some embodiments, an event timeline that includes one or more interactions between a customer and a supplier may be determined or otherwise obtained (e.g., from historical logs of a CRM (customer relationship management) system, complaint logs, invoicing systems, and the like). A starting performance value may be assigned to individual events in the event timeline. A sub-sequence comprising a portion of the event timeline that includes at least one reference event may be selected. A classifier may be used to determine a previous relative performance value for a previous event that occurred before the reference event and to determine a next relative performance value for a next event that occurred after the reference event until all events in the event timeline have been processed. The events in the event timeline may be traversed and a performance value assigned to individual events in the event timeline in some embodiments. The variation of the customer journeys from customer to customer can be quite large and pseudo random in nature, large enough to generate keys.

The present techniques may be used in the context of the systems and data models described in the following: U.S. Provisional Patent Application 62/698,769, filed 16 Jul. 2018, titled DYNAMIC RISK SCORING BASED ON TIME SERIES DATA, U.S. Provisional patent application Ser. No. 15/456,059, filed 10 Mar. 2017, titled BUSINESS ARTIFICIAL INTELLIGENCE MANAGEMENT ENGINE, and U.S. Provisional patent application Ser. No. 16/127,933, filed 11 Sep. 2018, titled MULTI-STAGE MACHINE-LEARNING MODELS TO CONTROL PATH-DEPENDENT PROCESSES. The entire content of each afore-listed earlier-filed application is hereby incorporated by reference for all purposes.

FIG. 2 illustrates some of the data model and programming constructs by which data and functionality may be organized, in some embodiments. ML-labels are shown in the ML-label class library 2000. KPI (key performance indicator) classes 2001 may be used to manage business problems. Business models include and are not limited to (which is not to suggest other lists are limiting herein) subscription and purchases. Customer class 2002 may capture the business/lifecycle of customers, whether consumers (for B2C) or businesses (for B2B). They include, but not limited to (which is not to suggest other lists are limiting herein), new customers, at-risk customers, or all customers. The item class 2003 may correspond to commercial items. Those items can be, and not limited to (which is not to suggest other lists are limiting herein), physical goods such as cars, services such as wireless phone contracts. These items can be hierarchical. That hierarchy or unstructured metadata can be set through classes. In this example, classes can include models, options, and customization. Some embodiments also include a horizon class 2004, with lifetime, time window, and calendar data.

The model class library 2005, in some embodiments, includes the scaled propensity/Cerebri Value 2006 (a proprietary name for a value which has the meaning attributed to this term in the applications incorporated by reference, enabled by Patent 10,783,535 and which generally is a measurement of customer engagement used to predict financial success), the timing gating class 2007, the affinity class 2008, and the compound best class 2009.

The class of compositions of model objects may be organized as a library 2010. Not all compositions apply to all pillars nor KPIs, in some cases. In some embodiments, model object compositions may include:
a. Sequence: In some cases, this class of mutators changes a collection of items into a time sequences for processing.
b. Feature: In some cases, this class uses accessors to gather one or more ML-feature of a model, one or more of properties, features, contexts, ML-state components, OO-state, and then use said features in another model object.
c. Economic optimization: In some cases, this class holds one or more economic objectives and zero or more economic constraints related to a unitary set of objects (typically, but not limited to (which is not to suggest other lists are limiting herein), a person, an product, a service) or a finite set of unitary set of objects (e.g., persons and products) or a finite set of unitary sets complemented by geo-temporal domain (e.g., persons and products and labor day in Maryland) and uses an allocation algorithm to maximize the objectives (which may include minimizing a loss function). Examples of objective functions include margin optimization, revenue, number of items sold, and carried interest. Examples of constraints include Cerebri Value range, cost of sales, and number of loan officers. Examples of optimization techniques include evolutionary algorithms, genetic algorithm (GA), simulated annealing, Tabu search, harmony search, stochastic hill-climbing, particle swarm optimization, linear programming, dynamic programming, integer programming, stochastic programming, stochastic gradient descent, and shortest path analysis.
d. Horse for courses: In some cases, this class uses accessors to gather and then analyze different performance measures from the Object Quality Management (OQM) attributes of models and context thereof to select which models out of the set of models to use for a specific set of contexts based on maximize quality value computed from elements of OQM. This class also analyzes different performance measures from the OQM attributes of models and context thereof to select which models out of the set of models to use for a specific set of contexts based on maximize quality value computed from elements of OQM.
e. Layering: In some cases, this class use accessors to gather and then analyze different measures from the OQM attributes of models and OO-features thereof organized along a semantically preset taxonomy or ontology to select which performance measures should be used per OOM-feature for use in a specific set of contexts. This class also analyzes different measures from the OQM attributes of models and OO-features thereof organized along a semantically preset taxonomy or ontology to select which performance measures should be used per OOM-feature for use in a specific set of contexts.
f. Ensembling: In some cases, this class use accessors to gather and then analyze the outputs and combine the decisions from multiple models to improve the overall performance.
g. Publishing/subscribing: In some cases, this class uses accessors to gather relevant attributes and organize them according to ontologies and mutators using those attributes.

In some embodiments, modeling methodologies class 2011 may capture key accessors, mutators. Contextualization classes 2012 may include, but are not limited to (which is not to suggest that other descriptions are limiting), binning (such as mapping of continuous attributes into discrete ones), winnowing (such as reduction of time span, location foci, and branches in a semantic tree), selection of data sources, and selection of KPIs (key performance indicators).

In some embodiments, binding classes 2013 may include binding (e.g., association) of four types of datasets (e.g., training, test, validation, and application). The governance classes 2014 my capture the restrictions and business protocols for specific KPIs. They include, but are not limited to (which is not to suggest other descriptions are limiting), OR criteria, operational criteria, actions that are allowed, and action density (e.g., number of actions per unit time).

In some embodiments, deployment classes 2016 may include realizations that include, and are not limited to (which is not to suggest other descriptions are limiting), Cerebri Values (like those described in applications incorporated by reference), and numerous KPIs, organized as primary and secondary, collectively at 2017. It also may include data quality monitoring (DQM), model quality monitoring (MQM), score quality monitoring (SQM) and label quality monitoring (LQM), collectively referred to as object quality management (OQM)

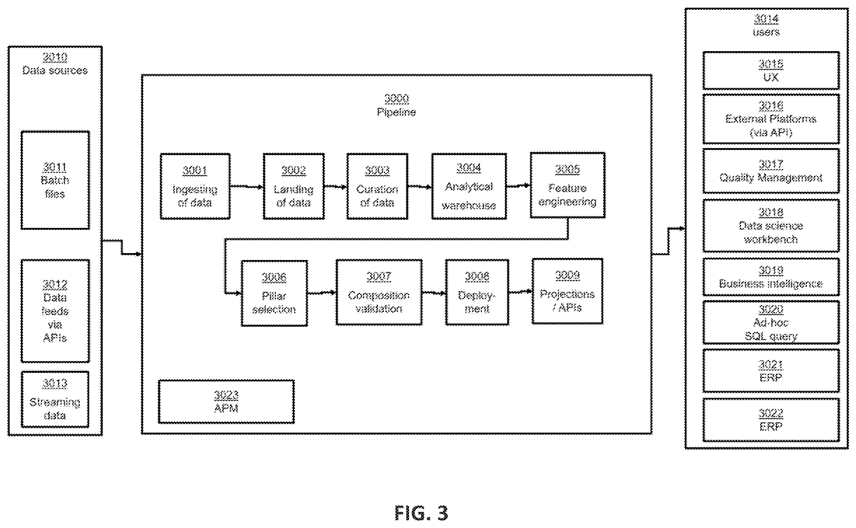

Details of an example machine-learning pipeline are provided in FIG. 3 in accordance with some embodiments. The overall pipeline 3000 may reside in memory and supports a series of stages. The ingestion of data module 3001 may control for input data (e.g., training or run-time data upon which inference is to be performed with a trained model) and schema drift, checks on file headers, version numbers are added to incoming files, data are routed into clean/error queues, and data files are archived in their raw format. With the landing module 3002, error records may be cleaned, column types may be changed from string to specific data types, version number may be updated, and data may be persisted. The data curation module 3003 may process incremental data incrementally, process performs, normalize data, aggregate data, impute data, create persistent keys, add keys, de-duplicate data, perform referential integrity checks, perform data quality checks based on value thresholds, perform value formatting, apply perform client specific column names, update version numbers, and persist data.

In some embodiments, analytical warehouse module 3004 may organize data in dimensional star schema or denormalized database structures, change column names from client specific to domain specific, add extension tables as key value stores for client specific attributes, update version numbers, and persist data.

In some embodiments, feature engineering module 3005 may change data from dimensional star schema to a denormalized flat table and cause data to be granularized at the event, customer, customer-product pair, or customer-date pair.

In some embodiments, pillar selection module 3006 may select which pillar (e.g., propensity, affinity, recommendation, or engagement) forms the basis of the modelling for the problems being solved by the pipeline.

In some embodiments, composition module 3007 may select how the pillars will be used and optimized based on model performance statistics such as, and not limited to (which is not to suggest that other lists are limiting), recall, accuracy, precision, brier gain, lift statistics, entropy, and average simulated expected return (e.g., total discounted future reward) using action entropy coverage.

In some embodiments, deployment module 3008 may score the models and retrain the models as needed. Module 3008 may create insights such scores, lists, ranked lists, feature analysis, and collection of feature or actions.

In some embodiments, composition module 3009 may manage how results and organized in OLAP cubes or equivalent multiple-dimensional datasets for slicing, dicing, drilling down, drilling up, or pivoting. It may create a data pump for readily projecting the computed insights.

In some embodiments, data sources 3010 include, among others, batch files 3011, data feeds though APIs (application program interfaces) 3012, and streaming data 3013. Users 3014 of the pipeline include a user interface 3015, external APIs 3016, quality management systems 3017, data science workbenches 3018, business intelligence systems 3019, ad-hoc SQL query 3020, enterprise resource planning (ERP) systems 3021, customer relationship management (CRM) systems 3022. One element of pipeline may be an application performance monitoring (APM) system 3023. One function of system 3023 may be monitoring APIs for junk or unusual data entering the pipeline 3000 from an untrusted entity potentially seeking to probe the pipeline to extract information intended to remain confidential.

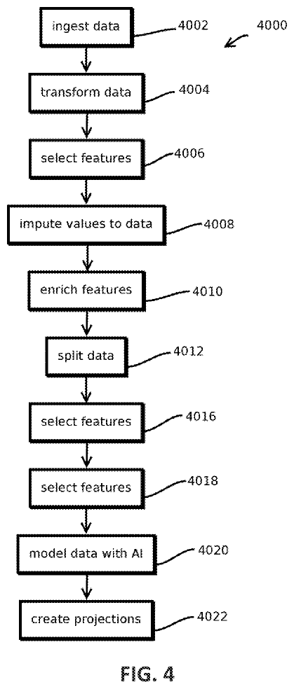

In some embodiments, the overall pipeline may execute a process 4000 shown in FIG. 4. In some embodiments, different subsets of this process may be executed by the illustrated components of the pipeline, so those features are described herein concurrently. It should be emphasized, though, that embodiments of the process are not limited to implementations with the architecture of FIG. 2 and FIG. 3, and that the architecture of FIG. 2 and FIG. 3 may execute processes different from that described with reference to FIG. 4, none of which is to suggest that any other description herein is limiting.

Process 4000 may include ingesting data (e.g., training or inference-time data) 4002, transforming the data (e.g., with an ETL process) 4004, selecting initial features 4006, imputing values to the data 4008 (e.g., by classifying the data), enriching the features 4010 (e.g., by cross-referencing other data sources), splitting the data (e.g., into bins or batches) 4012, selecting features useful for a first objective (like for cohort analysis) 4016, selecting features for a second objective (like time-series analysis) 4018, modeling the data with an AI model 4020, and creating projections based on outputs of the model 4022.

In some embodiments, an efficient and scalable way to create a machine learning system is through pipelining data processing, model processing, and projecting results for consumption. The elements of this pipeline (at times referred to as stages, racks, zones, operations, modules) may each be optimized (a term which does not require a global optimum and encompasses being proximate a local optimum) for functionality and performance as a single element or along with others. The nominal organization of such a pipeline may include: initialization, data intake, imputing (across time, location), and features enrichment, splitting, upsampling. downsampling, Markov blanket, feature selection, modelling, post-processing, persisting, presenting.

In some embodiments, changing the sequence of operations in a machine learning pipeline may dramatically impact the performance of an overall model in various dimensions, such as the time required to train, validate, or score the model. For instance, whether the transformation of a time series into a stationary time series before imputing data rather than imputing then transforming might yield different performance.

In some embodiments, most modeling, operation research, optimization, statistical analysis, and data science techniques (or other forms of machine learning modeling techniques MLMTs) may be parametrized, allowing for adaptation to different datasets and data models. The selection of parameters for MLMTs can be time-consuming, making their values (and relative values) valuable.

The MLMTs that may be used embodiments include, but not limited to (which is not to suggest that other lists are limiting): Ordinary Least Squares Regression (OLSR), Linear Regression, Logistic Regression, Stepwise Regression, Multivariate Adaptive Regression Splines (MARS), Locally Estimated Scatterplot Smoothing (LOESS), Instance-based Algorithms, k-Nearest Neighbor (KNN), Learning Vector Quantization (LVQ), Self-Organizing Map (SOM), Locally Weighted Learning (LWL), Regularization Algorithms, Ridge Regression, Least Absolute Shrinkage and Selection Operator (LASSO), Elastic Net, Least-Angle Regression (LARS), Decision Tree Algorithms, Classification and Regression Tree (CART), Iterative Dichotomizer 3 (ID3), C4.5 and C5.0 (different versions of a powerful approach), Chi-squared Automatic Interaction Detection (CHAID), Decision Stump, M5, Conditional Decision Trees, Naive Bayes, Gaussian Naive Bayes, Multinomial Naive Bayes, Averaged One-Dependence Estimators (AODE), Bayesian Belief Network (BBN), Bayesian Network (BN), k-Means, k-Medians, Expectation Maximization (EM), Hierarchical Clustering, Association Rule Learning Algorithms, A-priori algorithm, Eclat algorithm, Artificial Neural Network Algorithms, Perceptron, Back-Propagation, Hopfield Network, Radial Basis Function Network (RBFN), Deep Learning Algorithms, Reinforcement Learning (RL), Deep Boltzmann Machine (DBM), Deep Belief Networks (DBN), Convolutional Neural Network (CNN), Stacked Auto-Encoders, Dimensionality Reduction Algorithms, Principal Component Analysis (PCA), Principal Component Regression (PCR), Partial Least Squares Regression (PLSR), Multidimensional Scaling (MDS), Projection Pursuit, Linear Discriminant Analysis (LDA), Mixture Discriminant Analysis (MDA), Quadratic Discriminant Analysis (QDA), Flexible Discriminant Analysis (FDA), Ensemble Algorithms, Boosting, Bootstrapped Aggregation (Bagging), AdaBoost, Stacked Generalization (blending), Gradient Boosting Machines (GBM), Gradient Boosted Regression Trees (GBRT), Random Forest, Computational intelligence such as but not limited to evolutionary algorithms, PageRank based methods, Computer Vision (CV), Natural Language Processing (NLP), and Recommender Systems.

In some embodiments, feature engineering may be a part of a performing machine pipeline. Features original to the raw datasets are supplemented by features extracted through mathematical processing. Feature engineering is at times referred to as data enrichment, data supplementation, data engineering. Herein, these terms are used interchangeably.

In some embodiments, changing features, even in a subtle manner, may dramatically impact the performance of an overall model and create incentives to not tamper with the pipeline provided by a party. (None of which is to suggest that this or any other approach is disclaimed.)

Methods for feature engineering include but are not limited to (which is not to suggest that other lists are limiting): missing data imputation such as complete case analysis, mean/median/mode imputation, random forest imputation, KNN-imputation. DFM imputation, random sample imputation, replacement by arbitrary value, missing value indicator, multivariate imputation; categorical encoding such as one hot encoding, count and frequency encoding, binning, target encoding/mean encoding, ordinal encoding, weight of evidence, rare label encoding, baseN, feature hashing; variable transformation such logarithm, reciprocal, square root, exponential, Yeo-Johnson, box-cox; discretization such as equal frequency discretization, equal length discretization, discretization with trees, discretization with chi-merge, outlier removal, removing outliers, treating outliers as NaN, capping, windsorisation; feature scaling such as standardization, minmax scaling, mean scaling, max absolute scaling, unit norm-scaling, date and time engineering, extracting days, months, years, quarters, time elapsed, feature creation, sum, subtraction, mean, min, max, product, quotient of group of features, extracting features from text: bag of words, TFIDF, n-grams, word2vec, topic extraction.

Other methods for feature engineering are statistical in nature and include but are not limited to (which is not to suggest that other lists are limiting): calculating a feature matrix and features given a dictionary of entities and a list of relationships, calculating analysis of variance (ANOVA), calculating average-linkage clustering: a simple agglomerative clustering algorithm, calculating Bayesian statistics, calculating if all values are ‘true’ in a list, calculating the approximate haversine distance between two latlong variable types, calculating the cumulative count, calculating the cumulative maximum, calculating the cumulative mean, calculating the cumulative minimum, calculating the cumulative sum, calculating the entropy for a categorical variable, calculating the highest value, ignoring nan values, calculating the number of characters in a string, calculating the smallest value, ignoring nan values, calculating the time elapsed since the first datetime (in seconds), calculating the time elapsed since the last datetime (default in seconds), calculating the total addition, ignoring nan, calculating the trend of a variable over time, calculating time from a value to a specified cutoff datetime, calculating the normalization constant g(k) Gordon-Newell theorem, computing the difference between the value in a list and the previous value in that list, computing the time since the previous entry in a list, computing the absolute value of a number, computing the average for a list of values, computing the average number of seconds between consecutive events, computing the dispersion relative to the mean value, ignoring nan, computing the extent to which a distribution differs from a normal distribution, calculating the conjoint analysis, calculating correlation or cross-correlation, determining if a date falls on a weekend, determining if any value is ‘true’ in a list, determining the day of the month from a datetime, determining the day of the week from a datetime, determining the first value in a list, determining the hour value of a datetime, determining the last value in a list, determining the middlemost number in a list of values, determining the minutes value of a datetime, determining the month value of a datetime, determining the most commonly repeated value, determining the number of distinct values, ignoring nan values, determining the number of words in a string by counting the spaces, determining the percent of true values, determining the percentile rank for each value in a list, determining the seconds value of a datetime, determining the total number of values, excluding NaN, determining the week of the year from a datetime, determining the year value of a datetime, determining whether a value is present in a provided list, estimating the state of a linear dynamic system from a series of noisy measurements, calculating expectation-maximization algorithm, leveraging factor analysis, calculating false nearest neighbor algorithm (FNN), calculating further information: computational statistics, calculating fuzzy c-means, extracting parameters hidden Markov models, extracting mean square weighted deviation (MSVD), negating a Boolean value, extracting partial least squares regression, computing Pearson product-moment correlation coefficient, leveraging queuing theory, performing regression analysis, representing a computer network address, representing a date of birth as a datetime, representing a person's full name, representing a postal address in the united states, representing an iso-3166 standard country code, representing an iso-3166 standard sub-region code, representing any valid phone number, representing differences in time, representing time index of entity, representing time index of entity that is a datetime, representing time index of entity that is numeric, representing variables that are arbitrary strings, representing variables that are points in time, representing variables that can take an unordered discrete values, representing variables that contain numeric values, representing variables that identify another entity, representing variables that take on an ordered discrete value, representing variables that take on one of two values, representing variables that uniquely identify an instance of an entity, computing Pearman's rank correlation coefficient, computing student's t-test, computing time series analysis, calculating a feature matrix and features given a dictionary of entities and a list of relationships, computing Analysis of variance (ANOVA), calculating if all values are ‘True’ in a list, calculating the approximate haversine distance between two Lat-Long variable types, calculating the cumulative count, calculating the cumulative maximum, calculating the cumulative mean, calculating the cumulative minimum, calculating the cumulative sum, calculating the entropy for a categorical variable, calculating the highest value, ignoring NaN values, calculating the number of characters in a string, calculating the smallest value, ignoring NaN values, calculating the time elapsed since the first datetime (in seconds), calculating the time elapsed since the last datetime (default in seconds), calculating the total addition, ignoring NaN, calculating the trend of a variable over time, calculating time from a value to a specified cutoff datetime, calculating the normalization constant G(K) Gordon-Newell theorem, clustering algorithms, computing the difference between the value in a list and the previous value in that list, computing the time since the previous entry in a list, computing the absolute value of a number, computing the average for a list of values, computing the average number of seconds between consecutive events, computing the dispersion relative to the mean value, ignoring NaN, computing the extent to which a distribution differs from a normal distribution, computing Conjoint Analysis, computing Correlation or cross-correlation, determining if a date falls on a weekend, determining if any value is ‘True’ in a list, determining the day of the month from a datetime, determining the day of the week from a datetime, determining the first value in a list, determining the hour value of a datetime, determining the last value in a list, determining the middlemost number in a list of values, determining the minutes value of a datetime, determining the month value of a datetime, determining the most commonly repeated value, determining the number of distinct values, ignoring NaN values, determining the number of words in a string by counting the spaces, determining the percent of True values, determining the percentile rank for each value in a list, determining the seconds value of a datetime, determining the total number of values, excluding NaN, determining the week of the year from a datetime, determining the year value of a datetime, determining whether a value is present in a provided list, computing Element-wise logical AND of two lists, computing element-wise logical OR of two lists, computing Estimate the state of a linear dynamic system from a series of noisy measurements, computing Expectation-maximization algorithm, computing Factor analysis, computing False nearest neighbor algorithm (FNN), computing Further information: Computational statistics, computing Fuzzy c-means, computing Fuzzy clustering: a class of clustering algorithms where each point has a degree of belonging to clusters, computing Hidden Markov models, computing Mann-Whitney U, computing Mean square weighted deviation (MSWD), Negating a Boolean value, computing Pearson product-moment correlation coefficient, computing Regression analysis, representing a computer network address, representing a date of birth as a datetime, representing a person's full name, representing a postal address in the United States, representing a valid filepath, absolute or relative, representing a valid web url (with or without http/www), representing an email box to which email message are sent, representing an entity in an entity set, and stores relevant metadata and data, representing an ISO-3166 standard country code, representing an ISO-3166 standard sub-region code, representing any valid phone number, representing differences in time, representing time index of entity, representing time index of entity that is a datetime, representing time index of entity that is numeric, representing variables that are arbitrary strings, representing variables that are points in time, representing variables that can take an unordered discrete values, representing variables that contain numeric values, representing variables that identify another entity, representing variables that take on an ordered discrete value, representing variables that take on one of two values, representing variables that uniquely identify an instance of an entity, computing Spearman's rank correlation coefficient, and computing Student's t-test.

Other methods for feature engineering are geared towards time-series, longitudinal in nature. They include but are not limited to (which is not to suggest that other lists are limiting): calculating a linear least-squares regression for the values of the time series versus the sequence from zero to length of the time series minus one, calculating and return sample entropy of x, calculating a Continuous wavelet transform for the Ricker wavelet, calculating a Continuous wavelet transform for the Ricker wavelet, calculating a linear least-squares regression for values of the time series that were aggregated over chunks versus the sequence from zero up to the number of chunks minus one, calculating the Fourier coefficients of the one-dimensional discrete Fourier Transform for real input by fast, calculating the highest value of the time series x, calculating the lowest value of the time series x, calculating the number of crossings of x on m, calculating the number of peaks of at least support n in the time series x, calculating the q quantile of x, calculating the sum of squares of chunk i out of N chunks expressed as a ratio with the sum of squares over the whole series, calculating the sum over the time series values, calculating the value of the partial autocorrelation function at the given lag, calculating if any value in x occurs more than once, calculating if the maximum value of x is observed more than once, calculating if the minimal value of x is observed more than once, Counting observed values within the interval [min, max), Counting occurrences of value in time series x, Implementing a vectorized Approximate entropy algorithm, calculating Ratio of values that are more than r*std(x) (so r sigma) away from the mean of x, calculating a factor which is 1 if all values in the time series occur only once, and below one if this is not the case, calculating the absolute energy of the time series which is the sum over the squared values, calculating the first location of the maximum value of x, calculating the first location of the minimal value of x, calculating the kurtosis of x (calculated with the adjusted Fisher-Pearson standardized moment coefficient G2), calculating the last location of the minimal value of x, calculating the length of the longest consecutive subsequence in x that is bigger than the mean of x, calculating the length of the longest consecutive subsequence in x that is smaller than the mean of x, calculating the length of x, calculating the mean of x, calculating the mean over the absolute differences between subsequent time series values which is, calculating the mean over the differences between subsequent time series values which is, calculating the mean value of a central approximation of the second derivative, calculating the median of x, calculating the number of values in x that are higher than the mean of x, calculating the percentage of unique values, that are present in the time series more than once, calculating the ratio of unique values, that are present in the time series more than once, calculating the ratio of unique values, that are present in the time series more than once, calculating the relative last location of the maximum value of x, calculating the relative last location of the maximum value of x, calculating the sample skewness of x (calculated with the adjusted Fisher-Pearson standardized moment coefficient G1), calculating the spectral centroid (mean), variance, skew, and kurtosis of the absolute Fourier transform spectrum, calculating the standard deviation of x, calculating the standard deviation of x, calculating the sum of all data points, that are present in the time series more than once, calculating the sum of all values, that are present in the time series more than once, calculating the sum over the absolute value of consecutive changes in the series x, calculating the variance of x.

A powerful class of machine learning pipelines leverage the time component of user interactions with systems, which leads to specialized feature engineering. Such pipelines may use an entity log (organized potentially as user or customer journeys), and the entity logs may include events involving the users, where a first subset of the events are actions by the users, at least some of the actions by the users are targeted actions, and the events are labeled according to an ontology of events having a plurality of event types. Some embodiments may perform training, with one or more processors, based on the entity logs, a predictive machine learning model to predict whether an entity characterized by a set of inputs to the model will engage in a targeted action in a given duration of time in the future.

In some embodiments, the ontology of events used for organization is kept in the secure area and is accessible solely through APIs.

To protect the feature engineering aspect of the machine learning pipeline, some embodiments attach specific metadata for feature engineering or engineered features. Some embodiments obfuscate the name of the features.

Metrics of model performance may include count, unique count, null count, null count percentage, mean, standard-deviation, min, max, median, missing data source, data type change, missing data element, Accuracy, Accuracy Ratio, Precision, Recall, F1, ROC AUC, TPR, TNR, 1-FPR, 1-FNR, brier gain, 1-KS, lift statistic, model-based AER, 90% CI for model-based AER, IQR, Model-free AER, Aligned action percentage, Simplified doubly robust AER, Importance sampling-based AER, Doubly robust AER, Risky state model-based AER, and action entropy coverage.

Some embodiments implement a method for adding tamper resistance to a multi-stage machine-learning pipeline program (e.g., streaming, batch, or combined) The method may include installing a plurality of guard features at transformations in a multi-stage machine-learning pipeline program, wherein each of the plurality of guard features is executable (e.g., after being compiled or interpreted) to verify the integrity of at least of at least one other of the plurality of guard features, and wherein the integrity of at least one transformation of each of the plurality of guards is verified by at least one other of the plurality of guards. In some embodiments, the guard feature is a homomorphic encryption of a recency computation (e.g., how recently did the customer purchase?), a homomorphic encryption of a frequency computation (e.g., how often did the customer purchase?), or a homomorphic encryption of a monetary value computation (e.g., how much did the customer spend?). In some embodiments, the guard feature is a homomorphic encryption of Shapley value computation or other measure of network centrality, like closeness centrality, harmonic centrality, betweenness centrality, Eigenvector centrality, Katz centrality. PageRank centrality, percolation centrality, cross-clique centrality, Freeman centrality, or the like.

In some embodiments, the guard feature is the time aggregation parameters for the event log. In another embodiment, the guard feature is the time aggregation logic for the event log.

By leveraging wide variations of customer journeys and controls of the MLDTs, some embodiments insert artificial constructs such as watermarks and fingerprints that help counter piracy.

Some embodiments limit operation of the artificial intelligence and machine learning model beyond a time duration or scope of use specific in an end user license agreement or similar termporal threshold. This can be accomplished, in some embodiments, by, for example, checking the date of operation of the pipeline. In some embodiments, the limitation is performed by stopping the ingestion of specific data type after a specific date (or set of dates on a per source basis).

FIG. 5 illustrates a process 5000 that may be executed by the above-described instrument instrumentors 40 or 42 to protect machine-learning assets (e.g., data or components). In some embodiments, the process 5000 is performed before machine-learning assets are provided from the trusted computing environment 12 to the un-trusted computing environments 14, in some cases with different instances of the process executed each time a different un-trusted computing environment 14 requests machine learning assets from the trusted computing environment 12 to impart distinct forms of protection that, in some cases, for some types of protection, indicate which un-trusted computing environment 14 is undertaking an attack. The forms of protection applied may be logged in association with the request and an identifier of the requestor for presentation in later alarms or cross referencing with logs.

In some embodiments, the process 5000 includes obtaining code and data implementing a machine-learning model, as indicated by block 5002. In some embodiments, the code specifies a machine learning pipeline with a collection of such models or a TTL process of such a pipeline, for example, in some embodiments, the code operates to specify the other aspects of the machine-learning pipeline example discussed above with reference to FIGS. 2 through 4. In some embodiments, the data includes parameters, hyperparameters, training data, and in some cases query time data, by which such models are or pipelines are configured or upon which they operate.

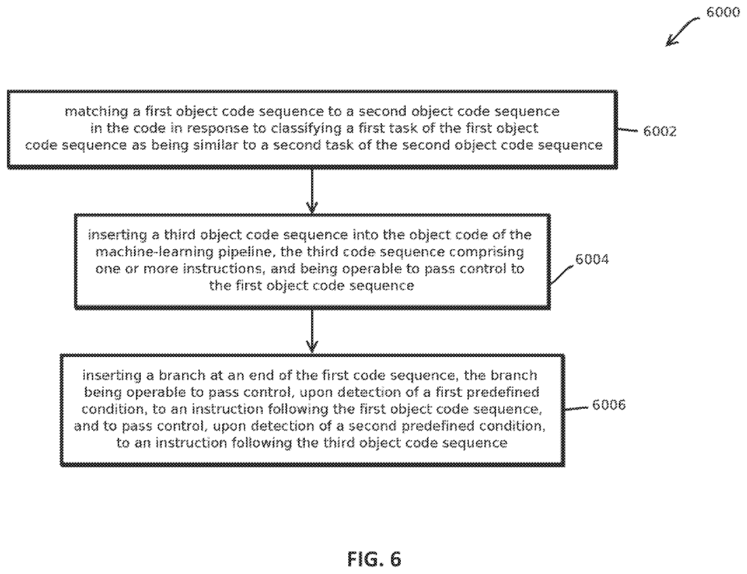

In some embodiments, the process 5000 includes modifying the code and data (or code or data) implementing the machine-learning model to make the code and data implementing the machine learning model more difficult to reverse engineer by probing the machine learning model with input data, as indicated by block 5004. In some embodiments, both code and data are modified, and in some embodiments just one of code or data is modified. Making the machine learning model more difficult to reverse engineer with such modification may be performed with techniques like those described below with reference to FIG. 6 through 12, which describe various forms of such modification.

Some embodiments include storing the modified code and data implementing the machine-learning model in memory, as indicated by block 5006. Some embodiments may further provide the modified code and data to a requesting un-trusted computing environment 14 like those described above with reference to FIG. 1. In some cases, the modifications may impede attempts by parties having elevated access privileges within those computing environments 14 to reverse engineer the corresponding machine learning assets embodied by the code and data.

FIG. 6 illustrates an example of a process 6000 by which code is modified to impede reverse engineering efforts. In some embodiments, the process 6000 is performed without access to source code of the corresponding machine-learning assets, for instance, by operating upon byte code or machine code representations (e.g., machine code compiled from byte code, which may be interpreted from source code). Or in some cases, the source code is available, and some embodiments transform either source code or object code or machine code representations. In some embodiments, the process 6000 includes matching a first object code sequence to a second object code sequence in the code (obtained in block 5002, which may be a subset of such code) to classify a first task of the first object code sequence as being similar to a second task of the second object code sequence, as indicated by block 6002.

In some embodiments, the object code is obtained by processing source code through an interpreter that transforms the source code into an object code representation suitable to be executed by a virtual machine within one of the un-trusted computing environments. Examples of object code include byte code formats of Java, Python, .NET, and other interpreted languages. In some embodiments, the object code is a byte code encoding that is generally not human interpretable but can be executed by a virtual machine configured for a host computing environment, such that the same object code representation or byte code may be executed on different types of computing hardware, within different operating systems, thereby simplifying the distribution of components into heterogenous computing environments.

The matching may take a variety of forms. The term “similar” here is not a subjective term and merely indicates that the tasks are classified as such for the purpose at hand, not that some subjective assessment is required. In some embodiments, similarity may be determined with hardcoded rules, or some embodiments may determine similarity by mapping object code sequences to an encoding space, or other latent space, vector representation in which distance between vectors corresponds to a measure of similarity, for instance, with an autoencoder trained and used to transform object code sequences into vector representations in a vector space with between 10 and 10,000 dimensions, and with distance in the encoding space being determined with Euclidean distance, Manhattan distance, cosine distance, or other measures. In some embodiments, similarity may be determined with an unsupervised learning techniques, for instance, with Latent Dirichlet Allocation or various forms of clustering (like DB-SCAN or k-means applied to vectors in the latent space).

Some embodiments include inserting a third object code sequence into the object code of the machine learning pipeline, with the third object code sequence including one or more instructions, and being operable to pass control to the first object code sequence, as indicated by block 6004. In some embodiments, inserting may include modifying a header of the section of object code (like a class or method header in a bytecode format) including the third object code sequence to indicate additional variables or instructions or memory allocation. In some embodiments, inserting further includes changing an index to be referenced by a virtual machine program counter of object code entries subsequent to the insertion to account for the insertion. In some embodiments, the inserted object code is operable to pass control with a bytecode command corresponding to a jump instruction that references as in an argument a sequence identifier of the first object code sequence.

Some embodiments include inserting a branch at an end of the first object code sequence, where the branch is operable to pass control, upon detection of a first predefined condition, to an instruction following the first object code sequence, and to pass control, upon detection of a second predefined condition, to an instruction following the third object code sequence, as indicated by block 6006.

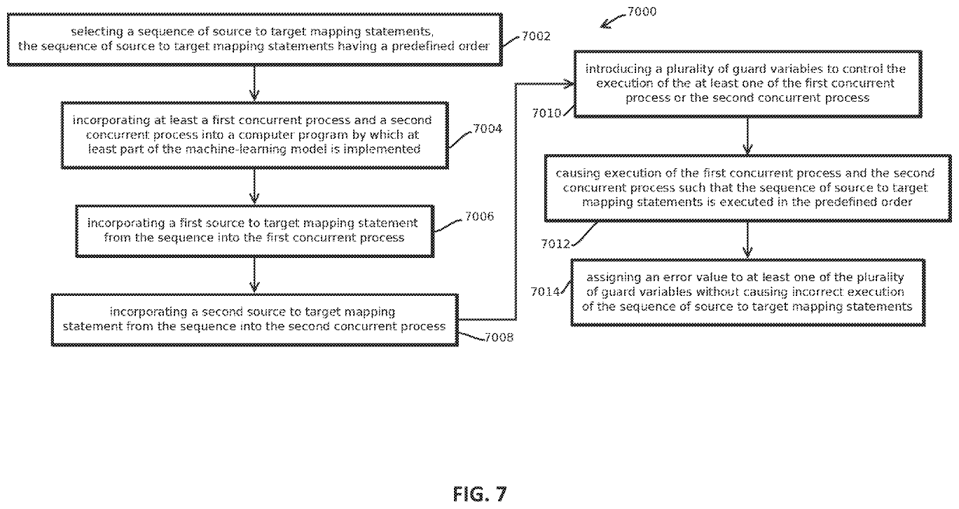

FIG. 7 illustrates another example of how the modifying step S004 may be implemented. These various examples of the modifying step S004 may be used in combination, or in the alternative. In some embodiments, modifying takes the form of process 7000 shown in FIG. 7, which may include selecting a sequence of source to target mapping statements, where the sequence of source to target mapping statements have a predefined order, as indicated by block 7002. In some embodiments, the source to target mapping statements are part of an extract, transform, and load portion of a machine-learning pipeline. In some embodiments, the source to target mapping statements may map fields, or collections thereof, of input data source to fields to a representation of the data in the machine-learning pipeline's schema, such as to features upon which the machine-learning pipeline operates. In some embodiments, the source to target mapping statements may be chained in an order indicated by the sequence.

In some embodiments, the process 7000 includes incorporating at least a first concurrent process and a second concurrent process into a computer program by which at least part of the machine-learning model is implemented, as indicated by block 7004. In some cases, these concurrent processes may be concurrent processes by which an ETL portion of a pipeline is implemented, for instance, by which different subsets of data from a given data source, or different data sources, are concurrently ingested and transformed into a form consistent with the data model of the pipeline.

Some embodiments further include incorporating a first source to target mapping statement from the sequence into the first concurrent process, as indicated by block 7006, and incorporating a second source to target mapping statement from the sequence into the second concurrent process, as indicated by block 7008. Some embodiments further include introducing a plurality of guard variables to control the execution of the at least one of the first concurrent process or the second concurrent process, as indicated by block 7010. In some embodiments, the guard variables may be variables that must evaluate to some state, such as true, in order for the process in which they are introduced to continue executing. In some embodiments, the corresponding machine-learning assets being executed (or a virtual machine configured to execute them) may be configured to enforce the required state of the guard variables for continued execution. Some embodiments further include causing execution of the first concurrent process and the second concurrent process (which may operation concurrently with respect to one another), such that the sequence of source to target mapping statements is executed in the predefined order, as indicated by block 712. In some embodiments, this process 712 may be executed as part of an ETL portion of a machine-learning pipeline.

Some embodiments include assigning an error value to at least one of the plurality of guard variables without causing incorrect execution of the sequence of source to target mapping statements, as indicated by block 714. Alternatively, some embodiments may decline to assign such an error value. In some embodiments, assigning may be based upon detecting signals indicative of reverse engineering attempts, such as detecting that a distribution of input data is outside of a tolerance in various attributes of distributions, has less than or greater than a threshold entropy, or fails various tests for being independent and identically distributed random variables, for example. In some embodiments, operation 714 may be performed within one of the un-trusted computing environments, along with operation 712, while the preceding steps of process 7000 may be performed within the trusted computing environment 12 in some embodiments.

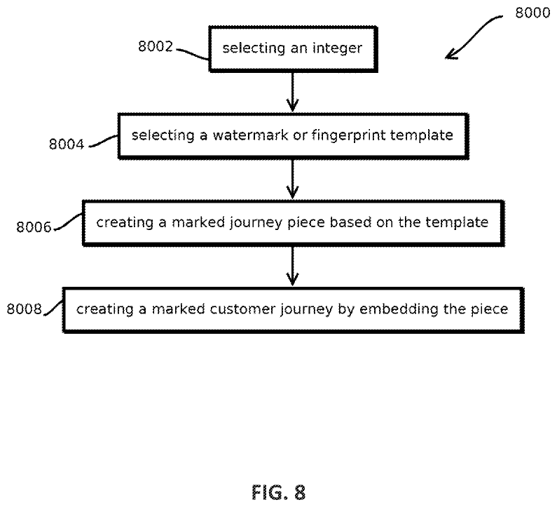

In some embodiments, modifying may include a process 8000 shown by FIG. 8 by which data is marked with a watermark or fingerprint to make tampering detectable. In some embodiments, the process 8000 includes selecting an integer, such as a watermark integer or a fingerprint integer, as indicated by block 8002. In some embodiments, the selection may be random, or pseudorandom, for instance implemented with a linear shift register advanced one increment at each execution of the process 8000. In some embodiments, the process 8000 further includes selecting a watermark or fingerprint template, as indicated by block 8004. In some embodiments, the selection may correspond to the selected integer, for instance from a class of fingerprint or watermark templates having at least one property, the property being an enumeration of such member fingerprint or watermark templates of the class. In some cases, the selected integer may index into a member of the class. In some embodiments, the templates may specify a format and distribution from which selections are made for various fields of a data entry, like a customer journey of the forms described elsewhere herein. In some embodiments, the fields and distributions may be selected to be unlikely or impossible within expected likely distributions processed in one of the un-trusted computing environments 14. In some embodiments, the templates may specify fields and distributions thereof for a subset of fields of a customer journey or other record.

Some embodiments include creating a marked journey piece based upon the template, as indicated by block 8006. In some embodiments, this may result in a watermark generated journey piece or a fingerprint generated journey piece, each corresponding to a subset, like a temporally contiguous subset, of a customer journey or other time-series or sequential record.

Some embodiments may further include creating a marked customer journey, or other record, by embedding the created marked journey piece within an existing customer journey or other record, for instance, within the training data 36 or input data 18. In some embodiments, embedding may include replacing existing data, inserting between entries in sequential order within existing data, or a combination thereof. In some embodiments, the creation operation 8006 may be based upon template fields that have variables corresponding to the entries in a customer journey to be modified, such that the template specifies how to customize the marked journey piece to be logically consistent with the customer journey to be modified.

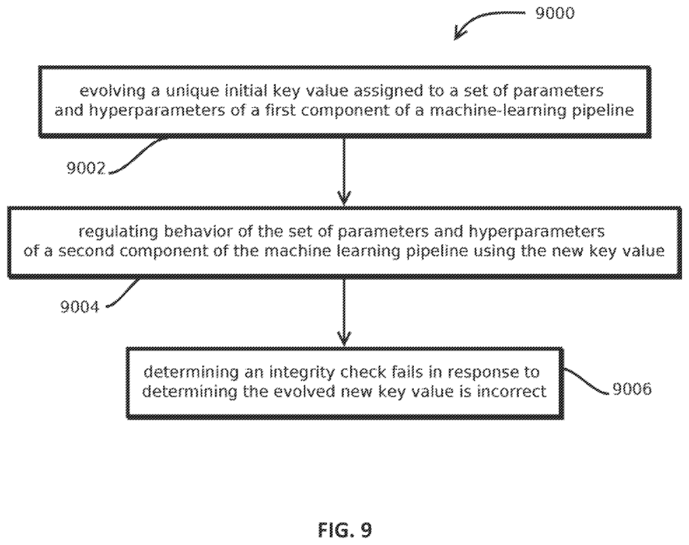

FIG. 9 illustrates another example of a process 9000 by which the modifying step S004 may be implemented. In some embodiments, the process 9000 includes a evolving a unique initial keyvalue assigned to a set of parameters and hyperparameters of a first component of a machine-learning pipeline, as indicated by block 9002. In some embodiments, the key may be unique among a population of keys corresponding to a set of components in a library of machine-learning components, like library 38 described above. In some embodiments, the unique initial key is evolved with components of the machine-learning pipeline executing an integrity check and using a one-way function that produces a new keyvalue within a chosen mathematical subgroup. For example, some embodiments may take as input a previous key and code of components or data of components of the machine learning pipeline and compute a cryptographic hash function result based thereon or other one-way function output based thereon, such as an output of some other form of cryptographic accumulator as the unique initial key. In some embodiments, the new keyvalue may stay within the mathematical subgroup unless tampering to the set of parameters and hyperparameters of the first component of the machine learning pipeline occurs. Some embodiments may include operations to detect whether the new keyvalue is within the subgroup and, in response to detecting it is not, cause an alarm to be logged or displayed to a user of the trusted computing environment 12. In some embodiments, this operation may be performed in the un-trusted computing environments 14 or the trusted computing environment 12.

Some embodiments include regulating behavior of the set of parameters and hyperparameters of a second component of the machine-learning pipeline using the new keyvalue, as indicated by block 9004. In some embodiments, operations may include determining whether an integrity check based on the new keyvalue fails, for example, if and only if the new keyvalue is incorrect, for example, as indicated by block 9006. Again, failures may be logged or prompt alarms to be presented, and some embodiments may block further operations involving the machine learning components at issue (if this or any other described check for tampering indicates tampering).

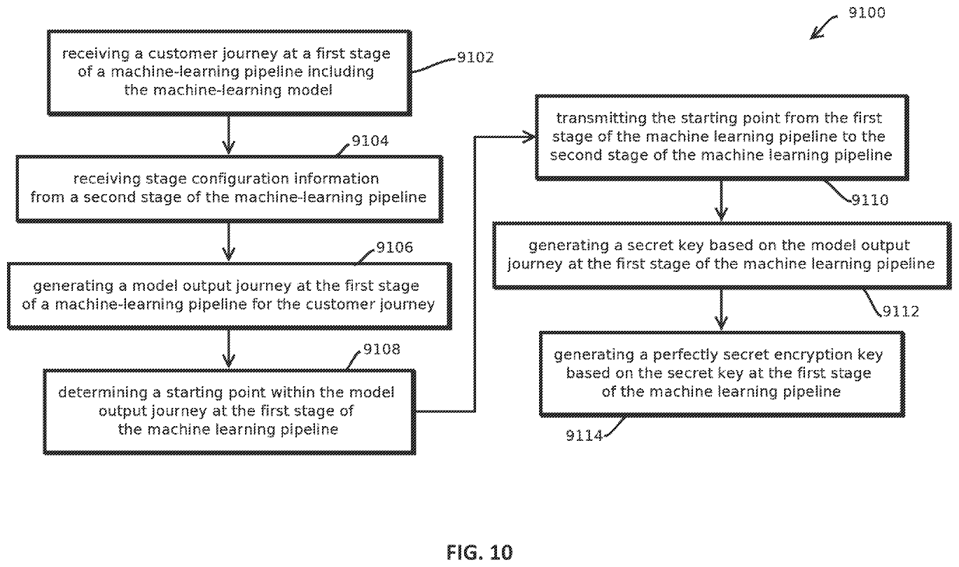

Some embodiments may implement a form of modifying in the step S004 that uses a process 9100 shown in FIG. 10. In some embodiments, this process may include receiving a customer journey at a first stage of a machine-learning pipeline including the machine-learning model noted in FIG. 5, as indicated by block 9102. Some embodiments may further receive stage configuration information from a second stage of the machine learning pipeline, as indicated by block 9104, and then generate a model output journey at the first stage of the machine learning pipeline for the customer journey, as indicated by block 9106. Some embodiments may then determine a starting point within the model output journey at the first stage of the machine learning pipeline, as indicated by block 9108. Some embodiments may proceed to transmit the starting point from the first stage of the machine learning pipeline to the second stage of the machine learning pipeline, as indicated by block 9110. Example stages are discussed above with reference to FIGS. 3 and 4. Some embodiments include generating a secret key based on the model output journey at the first stage of the machine learning pipeline, as indicated by block 9112. Some embodiments may then generate a perfectly secret encryption key based on the secret key at the first stage of the machine learning pipeline, as indicated by block 9114. In some embodiments, the encryption scheme implementing the perfectly secret encryption key may be provably secure against an adversary with unbounded computing power. Examples include a one-time pad encryption protocol.

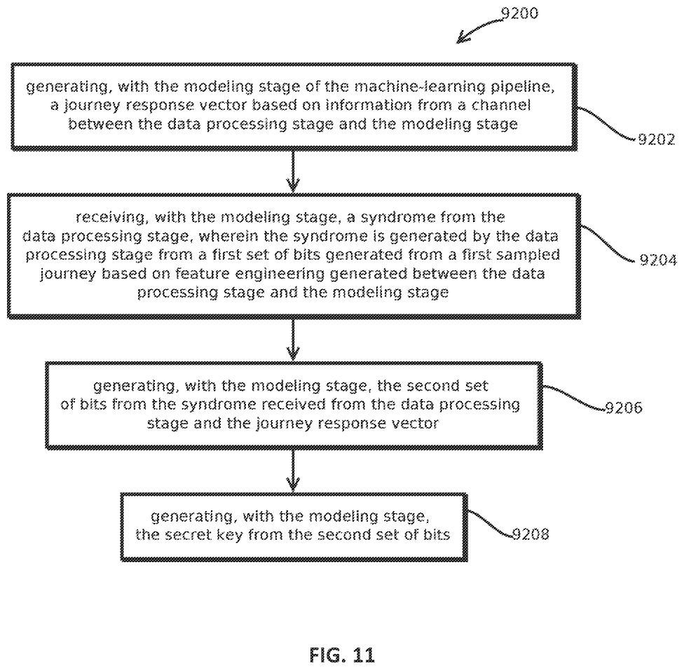

Some embodiments may implement the modifying step S004 with another process 9200 shown in FIG. 11. In some embodiments, this process 9200 may include generating, with the modeling stage of the machine-learning pipeline, a journey response vector based on information from a channel between the data processing stage and the modeling stage, as indicated by block 9202. Some embodiments then may receive, with the modeling stage, a syndrome from the data processing stage where the syndrome is generated by the data processing stage from a first set of bits generated from a first sample journey based on feature engineering generated between the data processing stage and the modeling stage, as indicated by block 9204. In some embodiments, the syndrome may be of the form used in syndrome decoding. Some embodiments may then generate, with the modeling stage, the second set of bits from the syndrome received from the data processing stage and the journey response vector, as indicated by block 9206. Some embodiments may then generate, with the modeling stage, the secret key from the second set of bits, as indicated by block 9208.

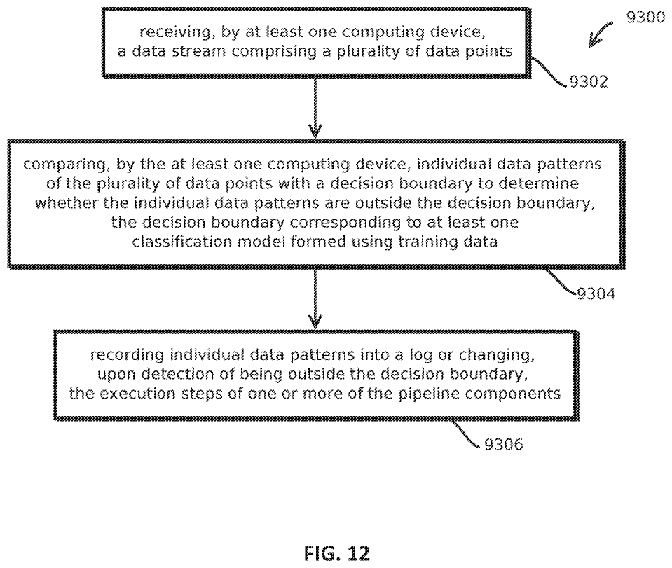

In some embodiments, the modifying step S004 may be implemented with the process 9300 shown in FIG. 12. Some embodiments may receive, by at least one computing device, a data stream comprising a plurality of data points, as indicated by block 9302. Some embodiments may compare, by the at least one computing device, individual data patterns of the plurality of data points with a decision boundary to determine whether the individual data patterns are outside the decision boundary, where the decision boundary corresponds to at least one classification model formed using the training data, as indicated by block 9304. In some embodiments, the classification model may include a supervised machine learning model trained on labeled examples of the training data. Some embodiments further include recording individual data patterns into a log or changing upon detection of being outside the decision boundary the executed steps of one or more pipeline components, as indicated by block 9304. Some embodiments may further, in response to detecting such an event, cause and alarm to be logged or presented within the trusted computing environment 12, indicating possible tampering

FIG. 13 is a diagram that illustrates an exemplary computing system 1000 in accordance with embodiments of the present technique, by which the present techniques may be implemented. Various portions of systems and methods described herein, may include or be executed on one or more computer systems similar to computing system 1000. Further, processes and modules described herein may be executed by one or more processing systems similar to that of computing system 1000.

Computing system 1000 may include one or more processors (e.g., processors 1010a-1010n) coupled to system memory 1020, an input/output I/O device interface 1030, and a network interface 1040 via an input/output (I/O) interface 1050. A processor may include a single processor or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 1000. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 1020). Computing system 1000 may be a uni-processor system including one processor (e.g., processor 1010a), or a multi-processor system including any number of suitable processors (e.g., 1010a-1010n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field programmable gate array) or an ASIC (application specific integrated circuit). Computing system 1000 may include a plurality of computing devices (e.g., distributed computer systems) to implement various processing functions.

I/O device interface 1030 may provide an interface for connection of one or more I/O devices 1060 to computer system 1000. I/O devices may include devices that receive input (e.g., from a user) or output information (e.g., to a user). I/O devices 1060 may include, for example, graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 1060 may be connected to computer system 1000 through a wired or wireless connection. I/O devices 1060 may be connected to computer system 1000 from a remote location. I/O devices 1060 located on remote computer system, for example, may be connected to computer system 1000 via a network and network interface 1040.

Network interface 1040 may include a network adapter that provides for connection of computer system 1000 to a network. Network interface may 1040 may facilitate data exchange between computer system 1000 and other devices connected to the network. Network interface 1040 may support wired or wireless communication. The network may include an electronic communication network, such as the Internet, a local area network (LAN), a wide area network (WAN), a cellular communications network, or the like.

System memory 1020 may be configured to store program instructions 1100 or data 1110. Program instructions 1100 may be executable by a processor (e.g., one or more of processors 1010a-1010n) to implement one or more embodiments of the present techniques. Instructions 1100 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one or more computer processors located locally at one site or distributed across multiple remote sites and interconnected by a communication network.

System memory 1020 may include a tangible program carrier having program instructions stored thereon. A tangible program carrier may include a non-transitory computer readable storage medium. A non-transitory computer readable storage medium may include a machine-readable storage device, a machine readable storage substrate, a memory device, or any combination thereof. Non-transitory computer readable storage medium may include non-volatile memory (e.g., flash memory, ROM, PROM, EPROM, EEPROM memory), volatile memory (e.g., random access memory (RAM), static random access memory (SRAM), synchronous dynamic RAM (SDRAM)), bulk storage memory (e.g., CD-ROM and/or DVD-ROM, hard-drives), or the like. System memory 1020 may include a non-transitory computer readable storage medium that may have program instructions stored thereon that are executable by a computer processor (e.g., one or more of processors 1010a-1010n) to cause the subject matter and the functional operations described herein. A memory (e.g., system memory 1020) may include a single memory device and/or a plurality of memory devices (e.g., distributed memory devices). Instructions or other program code to provide the functionality described herein may be stored on a tangible, non-transitory computer readable media. In some cases, the entire set of instructions may be stored concurrently on the media, or in some cases, different parts of the instructions may be stored on the same media at different times.

I/O interface 1050 may be configured to coordinate I/O traffic between processors 1010a-1010n, system memory 1020, network interface 1040, I/O devices 1060, and/or other peripheral devices. I/O interface 1050 may perform protocol, timing, or other data transformations to convert data signals from one component (e.g., system memory 1020) into a format suitable for use by another component (e.g., processors 1010a-1010n). I/O interface 1050 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 1000 or multiple computer systems 1000 configured to host different portions or instances of embodiments. Multiple computer systems 1000 may provide for parallel or sequential processing/execution of one or more portions of the techniques described herein.

Those skilled in the art will appreciate that computer system 1000 is merely illustrative and is not intended to limit the scope of the techniques described herein. Computer system 1000 may include any combination of devices or software that may perform or otherwise provide for the performance of the techniques described herein. For example, computer system 1000 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, or a Global Positioning System (GPS), or the like. Computer system 1000 may also be connected to other devices that are not illustrated, or may operate as a stand-alone system. In addition, the functionality provided by the illustrated components may in some embodiments be combined in fewer components or distributed in additional components. Similarly, in some embodiments, the functionality of some of the illustrated components may not be provided or other additional functionality may be available.

Those skilled in the art will also appreciate that while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network or a wireless link. Various embodiments may further include receiving, sending, or storing instructions or data implemented in accordance with the foregoing description upon a computer-accessible medium. Accordingly, the present techniques may be practiced with other computer system configurations.

In block diagrams, illustrated components are depicted as discrete functional blocks, but embodiments are not limited to systems in which the functionality described herein is organized as illustrated. The functionality provided by each of the components may be provided by software or hardware modules that are differently organized than is presently depicted, for example such software or hardware may be intermingled, conjoined, replicated, broken up, distributed (e.g. within a data center or geographically), or otherwise differently organized. The functionality described herein may be provided by one or more processors of one or more computers executing code stored on a tangible, non-transitory, machine readable medium. In some cases, notwithstanding use of the singular term “medium,” the instructions may be distributed on different storage devices associated with different computing devices, for instance, with each computing device having a different subset of the instructions, an implementation consistent with usage of the singular term “medium” herein. In some cases, third party content delivery networks may host some or all of the information conveyed over networks, in which case, to the extent information (e.g., content) is said to be supplied or otherwise provided, the information may provided by sending instructions to retrieve that information from a content delivery network.

The reader should appreciate that the present application describes several independently useful techniques. Rather than separating those techniques into multiple isolated patent applications, applicants have grouped these techniques into a single document because their related subject matter lends itself to economies in the application process. But the distinct advantages and aspects of such techniques should not be conflated. In some cases, embodiments address all of the deficiencies noted herein, but it should be understood that the techniques are independently useful, and some embodiments address only a subset of such problems or offer other, unmentioned benefits that will be apparent to those of skill in the art reviewing the present disclosure. Due to costs constraints, some techniques disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such techniques or all aspects of such techniques.

It should be understood that the description and the drawings are not intended to limit the present techniques to the particular form disclosed, but to the contrary, the intention is to cover all modifications, equivalents, and alternatives falling within the spirit and scope of the present techniques as defined by the appended claims. Further modifications and alternative embodiments of various aspects of the techniques will be apparent to those skilled in the art in view of this description. Accordingly, this description and the drawings are to be construed as illustrative only and are for the purpose of teaching those skilled in the art the general manner of carrying out the present techniques. It is to be understood that the forms of the present techniques shown and described herein are to be taken as examples of embodiments. Elements and materials may be substituted for those illustrated and described herein, parts and processes may be reversed or omitted, and certain features of the present techniques may be utilized independently, all as would be apparent to one skilled in the art after having the benefit of this description of the present techniques. Changes may be made in the elements described herein without departing from the spirit and scope of the present techniques as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Terms describing conditional relationships, e.g., “in response to X, Y,” “upon X, Y,”, “if X, Y,” “when X, Y,” and the like, encompass causal relationships in which the antecedent is a necessary causal condition, the antecedent is a sufficient causal condition, or the antecedent is a contributory causal condition of the consequent, e.g., “state X occurs upon condition Y obtaining” is generic to “X occurs solely upon Y” and “X occurs upon Y and Z.” Such conditional relationships are not limited to consequences that instantly follow the antecedent obtaining, as some consequences may be delayed, and in conditional statements, antecedents are connected to their consequents, e.g., the antecedent is relevant to the likelihood of the consequent occurring. Statements in which a plurality of attributes or functions are mapped to a plurality of objects (e.g., one or more processors performing steps A, B, C, and D) encompasses both all such attributes or functions being mapped to all such objects and subsets of the attributes or functions being mapped to subsets of the attributes or functions (e.g., both all processors each performing steps A-D, and a case in which processor 1 performs step A, processor 2 performs step B and part of step C, and processor 3 performs part of step C and step D), unless otherwise indicated. Similarly, reference to “a computer system” performing step A and “the computer system” performing step B can include the same computing device within the computer system performing both steps or different computing devices within the computer system performing steps A and B. Further, unless otherwise indicated, statements that one value or action is “based on” another condition or value encompass both instances in which the condition or value is the sole factor and instances in which the condition or value is one factor among a plurality of factors. Unless otherwise indicated, statements that “each” instance of some collection have some property should not be read to exclude cases where some otherwise identical or similar members of a larger collection do not have the property, i.e., each does not necessarily mean each and every. Limitations as to sequence of recited steps should not be read into the claims unless explicitly specified, e.g., with explicit language like “after performing X, performing Y,” in contrast to statements that might be improperly argued to imply sequence limitations, like “performing X on items, performing Y on the X'ed items,” used for purposes of making claims more readable rather than specifying sequence. Statements referring to “at least Z of A, B, and C,” and the like (e.g., “at least Z of A, B, or C”), refer to at least Z of the listed categories (A, B, and C) and do not require at least Z units in each category. Unless specifically stated otherwise, as apparent from the discussion, it is appreciated that throughout this specification discussions utilizing terms such as “processing,” “computing,” “calculating,” “determining” or the like refer to actions or processes of a specific apparatus, such as a special purpose computer or a similar special purpose electronic processing/computing device. Features described with reference to geometric constructs, like “parallel,” “perpendicular/orthogonal,” “square”, “cylindrical,” and the like, should be construed as encompassing items that substantially embody the properties of the geometric construct, e.g., reference to “parallel” surfaces encompasses substantially parallel surfaces. The permitted range of deviation from Platonic ideals of these geometric constructs is to be determined with reference to ranges in the specification, and where such ranges are not stated, with reference to industry norms in the field of use, and where such ranges are not defined, with reference to industry norms in the field of manufacturing of the designated feature, and where such ranges are not defined, features substantially embodying a geometric construct should be construed to include those features within 15% of the defining attributes of that geometric construct. The terms “first”, “second”, “third,” “given” and so on, if used in the claims, are used to distinguish or otherwise identify, and not to show a sequential or numerical limitation. As is the case in ordinary usage in the field, data structures and formats described with reference to uses salient to a human need not be presented in a human-intelligible format to constitute the described data structure or format, e.g., text need not be rendered or even encoded in Unicode or ASCII to constitute text; images, maps, and data-visualizations need not be displayed or decoded to constitute images, maps, and data-visualizations, respectively; speech, music, and other audio need not be emitted through a speaker or decoded to constitute speech, music, or other audio, respectively. Computer implemented instructions, commands, and the like are not limited to executable code and can be implemented in the form of data that causes functionality to be invoked, e.g., in the form of arguments of a function or API call. To the extent bespoke noun phrases (and other coined terms) are used in the claims and lack a self-evident construction, the definition of such phrases may be recited in the claim itself, in which case, the use of such bespoke noun phrases should not be taken as invitation to impart additional limitations by looking to the specification or extrinsic evidence.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

The present techniques will be better understood with reference to the following enumerated embodiments:

1. A tangible, non-transitory, machine-readable medium storing instructions that when executed by one or more processors effectuate operations comprising: searching for a code representation of a machine learning pipeline to find a first and a second object code sequences, the first and the second object code sequences performing similar tasks; modifying the code representation of the machine learning pipeline by: inserting a third object code sequence into the code representation of the machine learning pipeline, the third code sequence comprising one or more instructions, and being operable to pass control to the first object code sequence; inserting a branch at an end of the first code sequence, the branch being operable to: pass control, upon detection of a first predefined condition, to an instruction following the first object code sequence, and to pass control, upon detection of a second predefined condition, to an instruction following the third object code sequence; and wherein the third code sequence is executed in place of the second object sequence without affecting completion of the tasks.

2. A tangible, non-transitory, machine-readable medium storing instructions that when executed by one or more processors effectuate operations comprising: searching for a code representation of a feature engineering stage to find a first and a second object code sequences, the first and the second object code sequences performing similar tasks; modifying the code representation of the feature engineering stage by: inserting a third object code sequence into the code representation of the feature engineering stage, the third code sequence comprising one or more instructions, and being operable to pass control to the first object code sequence; inserting a branch at the end of the first code sequence, the branch being operable to: pass control, upon detection of a first predefined condition, to an instruction following the first object code sequence, and to pass control, upon detection of a second predefined condition, to an instruction following the third object code sequence; an wherein the third code sequence is executed in place of the second object sequence without affecting completion of the tasks.

3. The tangible, non-transitory, machine-readable medium of embodiment 2, the medium further comprising: compiling the source code representation of the feature engineering stage to obtain an object code representation of said feature engineering stage.

4. The tangible, non-transitory, machine-readable medium of embodiment 3, wherein the first, the second and the third code sequences perform at least one of the following: injection affinity score, inject propensity score, compose target, extract statistical parameters, set parameters, explore parameters, enrich data, create a stream, publish a stream, subscribe to a stream, update a record, select a record, update a record, connect to a source, perform source to target mapping, connect to a sink, select a record, aggregate on one or more time dimensions, aggregate on one or more spatial dimensions, select features based on correlation, create lag based features, encode stationarity, encode seasonality, encode cyclicity, impute over range of dimension, regress, use deep learning to extract new features, leverage parameters from boosted gradient search, synthesis through generative adversarial networks, encode, morph outliers, bins, nonlinear transform, group, feature split, decimate, up sample, down sample, extract reliability, and changes attributes.

5. A tangible, non-transitory, machine-readable medium storing instructions that when executed by one or more processors effectuate operations comprising: searching for a code representation of a machine learning pipeline to find a first and a second object code sequences, the first and the second object code sequences performing similar tasks; modifying the code representation of the machine learning pipeline by: inserting a third object code sequence into the code representation of the machine learning pipeline, the third code sequence comprising one or more instructions, and being operable to pass control to the first object code sequence; inserting a branch at the end of the first code sequence, the branch being operable to: pass control, upon detection of a first predefined condition, to an instruction following the first object code sequence, and to pass control, upon detection of a second predefined condition, to an instruction following the third object code sequence; and wherein the third code sequence is executed ahead of the second object sequence without affecting completion of the tasks.

6. A tangible, non-transitory, machine-readable medium storing instructions that when executed by one or more processors effectuate operations comprising: selecting a sequence of source to target mapping statements, the sequence of source to target mapping statements having a predefined order; incorporating at least a first concurrent process and a second concurrent process into a computer program; incorporating at least a first source to target mapping statement from the sequence into the first concurrent process; incorporating at least a second source to target mapping statement from the sequence into the second concurrent process; introducing a plurality of guard variables to control the execution of the at least one first concurrent process and the second concurrent process; controlling execution of the first concurrent process and the second concurrent process such that the sequence of source to target mapping statements is executed in the predefined order; and assigning an error value to at least one of a plurality of guard variables without causing incorrect execution of the sequence of source to target mapping statements.

7. A method, comprising: selecting a sequence of source to target mapping statements, the sequence of source to target mapping statements having a predefined order; incorporating at least a first concurrent process and a second concurrent process into a computer program; incorporating at least a first source to target mapping statement from the sequence into the first concurrent process; incorporating at least a second source to target mapping statement from the sequence into the second concurrent process; introducing a plurality of guard variables to control the execution of the at least one first concurrent process and the second concurrent process; controlling execution of the first concurrent process and the second concurrent process such that the sequence of source to target mapping statements is executed in the predefined order; and assigning an error value to at least one of a plurality of guard variables without causing incorrect execution of the sequence of source to target mapping statements.

8. A tangible, non-transitory, machine-readable medium storing instructions that when executed by one or more processors effectuate operations comprising: selecting a watermark integer; selecting a watermark journey template; choosing the watermark journey template corresponding to the selected watermark integer from a class of watermark journey templates having at least one property, the at least one property being an enumeration such that each member watermark journey template of the class of watermark journey template is associated with one integer value; creating a watermark-generated journey piece with generated events and features of watermark journey template; and creating a watermarked customer journey by modifying the customer journey by embedding watermark-generated journey piece with customer journey in such a way that the watermark-generated journey piece becomes present and detectable in further processing of the watermarked customer journey said processing using substantially all events and features modified by the machine learning pipeline.

9. A tangible, non-transitory, machine-readable medium storing instructions that when executed by one or more processors effectuate operations comprising: selecting a fingerprint integer; selecting a fingerprint template choosing the fingerprint template corresponding to the selected watermark integer from a class of fingerprint template having at least one property, the at least one property being an enumeration such that each member fingerprint template of the class of fingerprint template is associated with one integer value; creating a fingerprint journey piece with generated events and features of watermark journey template; creating a fingerprinted customer journey by modifying the customer journey by embedding fingerprint journey piece with customer journey; and providing the fingerprinted customer journey to a one or more target computing device for execution, wherein the fingerprinted customer journey will only execute correctly on one or more target computing device.

10. A tangible, non-transitory, machine-readable medium storing instructions that when executed by one or more processors effectuate operations comprising: evolving a unique initial key value assigned to a set of parameters and hyperparameters of a first component of the machine learning pipeline, said components executing an integrity check and using a one-way function that produces a new key value within a chosen mathematical subgroup, such that the new key value will stay within the subgroup unless tampering to the set of parameters and hyperparameters of the first component of the machine learning pipeline occurs; regulating behavior of the set of parameters and hyperparameters of a second component of the machine learning pipeline using the new key value, such that the integrity check fails if the evolved new key value is incorrect; and the second component of the machine learning pipeline not functioning correctly.

11. The tangible, non-transitory, machine-readable medium 10, wherein parameters are global, local, categorical, longitudinal, or continuous.

12. A tangible, non-transitory, machine-readable medium storing instructions that when executed by one or more processors effectuate operations comprising: receiving a customer journey at a first stage of a machine learning pipeline; receiving stage configuration information from a second stage of a machine learning at the first stage of a machine learning pipeline; generating a model output journey at the first stage of a machine learning pipeline for the customer journey, wherein the model output journey is generated based, at least in part, on the stage configuration information from second stage; determining a starting point within the model output journey at the first stage of a machine learning pipeline; transmitting the starting point from the first stage of a machine learning pipeline to a second stage of a machine learning pipeline; generating a long secret key based on the model output journey at the first stage of a machine learning pipeline; and generating a perfectly secret encryption key based on the long secret key at the first stage of a machine learning pipeline.

13. A tangible, non-transitory, machine-readable medium storing instructions that when executed by one or more processors effectuate operations configured to perform a method of protecting machine learning pipeline components by generating a secret key from joint randomness shared by a data processing stage of a machine learning pipeline and a modeling stage of a machine learning pipeline, the medium comprising: the modeling stage of a machine learning second stage of a machine learning generating a journey response vector based on a channel between said data processing stage and said modeling stage; said modeling stage receiving a syndrome from said data processing stage, wherein the syndrome has been generated by said data processing stage from a first set of bits generated from a first sampled journey based on the feature engineering generated between said data processing stage and said modeling stage; said modeling stage generating the second set of bits from the syndrome received from said data processing stage and the journey response vector; and the modeling stage generating the secret key from the second set of bits.

14. A tangible, non-transitory, machine-readable medium storing instructions that when executed by one or more processors effectuate operations configured to perform a method of protecting machine learning pipeline components by generating a secret key from joint randomness shared by a data processing stage of a machine learning pipeline and a modeling stage of a machine learning pipeline, the medium comprising: receiving, by at least one computing device, a data stream comprising a plurality of data points; comparing, by the at least one computing device, individual data patterns of the plurality of data points with a decision boundary to determine whether the individual data patterns are outside the decision boundary, the decision boundary corresponding to at least one classification model formed using training data; and recording individual data patterns into a log.

15. A tangible, non-transitory, machine-readable medium storing instructions that when executed by one or more processors effectuate operations configured to perform a method of protecting machine learning pipeline components by generating a secret key from joint randomness shared by a data processing stage of a machine learning pipeline and a modeling stage of a machine learning pipeline, the medium comprising: receiving, by at least one computing device, a data stream comprising a plurality of data points; comparing, by the at least one computing device, individual data patterns of the plurality of data points with a decision boundary to determine whether the individual data patterns are outside the decision boundary, the decision boundary corresponding to at least one classification model formed using training data; and changing, upon detection of being outside the decision boundary, the execution steps of one or more of the pipeline components.

16. The medium of embodiment 15, comprising: steps for obfuscation.

17. A non-transitory computer readable medium storing instructions which, when executed by one or more computing devices, cause the one or more computing devices to perform a method of obfuscating the stages of a machine learning pipeline, the machine learning pipeline being designed to carry out one or more specified machine learning tasks, the method including: searching the code representation of the machine learning pipeline to find first and second code sequences, the first and second object code sequences performing similar tasks; and modifying the code representation of the machine learning pipeline by: inserting a third code sequence into the code representation of the machine learning pipeline, the third code sequence comprising one or more instructions, and being operable to pass control to the first code sequence; and inserting a branch at the end of the first code sequence, the branch being operable to: pass control, upon detection of a first predefined condition, to an instruction following the first code sequence, and

to pass control, upon detection of a second predefined condition, to an instruction following the third object code sequence; whereby the third code sequence is executed in place of the second object sequence without materially affecting completion of the one or more specified tasks.

18. A non-transitory computer readable medium storing instructions which, when executed by one or more computing devices, cause the one or more computing devices to perform a method of obfuscating the feature engineering stage of a machine learning pipeline, the machine learning pipeline being designed to carry out one or more specified feature engineering tasks, the method including: searching the code representation of the feature engineering stage to find first and second code sequences, the first and second code sequences performing similar tasks; and modifying the code representation of the feature engineering stage by: inserting a third code sequence into the code representation of the feature engineering stage, the third code sequence comprising one or more instructions, and being operable to pass control to the first object code sequence; and

inserting a branch at the end of the first code sequence, the branch being operable to: pass control, upon detection of a first predefined condition, to an instruction following the first code sequence, and to pass control, upon detection of a second predefined condition, to an instruction following the third code sequence; whereby the third code sequence is executed in place of the code sequence without materially affecting completion of the one or more specified feature engineering tasks.

19. A non-transitory computer readable medium storing instructions which, when executed by one or more computing devices, cause the one or more computing devices to perform a method of obfuscating the feature engineering stage of a machine learning pipeline, the machine learning pipeline being designed to carry out one or more specified feature engineering tasks, the method including: compiling a source code representation of the feature engineering stage to obtain an object code representation of said feature engineering stage; searching the object code representation of the feature engineering stage to find first and second object code sequences, the first and second object code sequences performing similar tasks; modifying the object code representation of the feature engineering stage by: inserting a third object code sequence into the object code representation of the feature engineering stage, the third object code sequence comprising one or more instructions, and being operable to pass control to the first object code sequence; and inserting a branch at the end of the first object code sequence, the branch being operable to: pass control, upon detection of a first predefined condition, to an instruction following the first object code sequence, and pass control, upon detection of a second predefined condition, to an instruction following the third object code sequence; whereby the third object code sequence is executed in place of the second object code sequence without materially affecting completion of the one or more specified feature engineering task.

20. A non-transitory computer readable medium storing instructions such as embodiment 2 where the first, second or third code sequences perform one or more of the following; injection affinity score, inject propensity score, compose target, extract statistical parameters, set parameters, explore parameters, enrich data, aggregate on one or more time dimensions, aggregate on one or more spatial dimensions, select features based on correlation, create lag based features, encode stationarity, encode seasonality, encode cyclicity, impute over range of dimension, regress, create a stream, publish a stream, subscribe to a stream, update a record, select a record, update a record, connect to a source, perform source to target mapping, connect to a sink, use deep learning to extract new features, leverage parameters from boosted gradient search, synthesis through generative adversarial networks, encode, morph outliers, bins, nonlinear transform, group, feature split, decimate, up sample, down sample, extract reliability, or changes attributes.

21. A non-transitory computer readable medium storing instructions which, when executed by one or more computing devices, cause the one or more computing devices to perform a method of obfuscating the feature engineering stage of a machine learning pipeline, the machine learning pipeline being designed to carry out one or more specified feature engineering tasks, the method including: compiling a source code representation of the feature engineering stage to obtain an object code representation of said feature engineering stage; searching the object code representation of the feature engineering stage to find first, second, and third object code sequences, the second code sequence performing tasks ahead of the third object code sequence performing tasks; and modifying the object code representation of the feature engineering stage by: inserting a third object code sequence into the object code representation of the feature engineering stage, the third object code sequence comprising one or more instructions, and being operable to pass control to the first object code sequence; and inserting a branch at the end of the first object code sequence, the branch being operable to: pass control, upon detection of a first predefined condition, to an instruction following the first object code sequence, and pass control, upon detection of a second predefined condition, to an instruction following the third object code sequence; whereby the third object code sequence is executed ahead of the second object code sequence.

22. A non-transitory computer readable medium storing instructions which, when executed by one or more computing devices, cause the one or more computing devices to perform a method of obfuscating the data processing stage of a machine learning pipeline, the machine learning pipeline being designed to carry out one or more specified data processing tasks, the method including: selecting a sequence of source to target mapping statements, the sequence of source to target mapping statements having a predefined order; incorporating at least a first concurrent process and a second concurrent process into the computer program; incorporating at least a first source to target mapping statement from the sequence into the first concurrent process; incorporating at least a second source to target mapping statement from the sequence into the second concurrent process; introducing a plurality of guard variables to control the execution of the at least one first concurrent process and the second concurrent process; controlling execution of the first concurrent process and the second concurrent process such that the sequence of source to target mapping statements is executed in the predefined order; and assigning an error value to at least one of a plurality of guard variables without causing incorrect execution of the sequence of source to target mapping statements.

23. A system for executing instructions, wherein said instructions are instructions which, when executed by one or more computing devices, cause performance of a process including: selecting a sequence of source to target mapping statements, the sequence of source to target mapping statements having a predefined order; incorporating at least a first concurrent process and a second concurrent process into the computer program; incorporating at least a first source to target mapping statement from the sequence into the first concurrent process; incorporating at least a second source to target mapping statement from the sequence into the second concurrent process; introducing a plurality of guard variables to control the execution of the at least one first concurrent process and the second concurrent process; controlling execution of the first concurrent process and the second concurrent process such that the sequence of source to target mapping statements is executed in the predefined order; and assigning an error value to at least one of a plurality of guard variables without causing incorrect execution of the sequence of source to target mapping statements.

24. A system for executing instructions, wherein said instructions are instructions which, when executed by one or more computing devices, cause performance of a process including: compiling a source code representation of the feature engineering stage to obtain an object code representation of said feature engineering stage; searching the object code representation of the feature engineering stage to find first and second object code sequences, the first and second object code sequences performing similar tasks; and modifying the object code representation of the feature engineering stage by: inserting a third object code sequence into the object code representation of the feature engineering stage, the third object code sequence comprising one or more instructions, and being operable to pass control to the first object code sequence; and inserting a branch at the end of the first object code sequence, the branch being operable to: pass control, upon detection of a first predefined condition, to an instruction following the first object code sequence, and pass control, upon detection of a second predefined condition, to an instruction following the third object code sequence; whereby the third object code sequence is executed in place of the second object code sequence without materially affecting completion of the one or more specified feature engineering task.

25. A non-transitory computer readable medium storing instructions which, when executed by one or more computing devices, cause the one or more computing devices to perform a method of watermarking a customer journey, wherein the one or more computing devices perform the method including: selecting a watermark integer; selecting a watermark journey template choosing the watermark journey template corresponding to the selected watermark integer from a class of watermark journey template having at least one property, the at least one property being an enumeration such that each member watermark journey template of the class of watermark journey template is associated with one integer value; creating a watermark-generated journey piece with generated events and features of watermark journey template; and creating a watermarked customer journey by modifying the customer journey by embedding watermark-generated journey piece with customer journey in such a way that the watermark-generated journey piece becomes present and detectable in further processing of the watermarked customer journey said processing using substantially all events and features modified by the machine learning pipeline.

26. A non-transitory computer readable medium storing instructions which, when executed by one or more computing devices, cause the one or more computing devices to perform a method of fingerprinting a customer journey, wherein the one or more computing devices perform the method including: selecting a fingerprint integer; selecting a fingerprint template choosing the fingerprint template corresponding to the selected watermark integer from a class of fingerprint template having at least one property, the at least one property being an enumeration such that each member fingerprint template of the class of fingerprint template is associated with one integer value; creating a fingerprint journey piece with generated events and features of watermark journey template; creating a fingerprinted customer journey by modifying the customer journey by embedding fingerprint journey piece with customer journey; and providing the fingerprinted customer journey to a one or more target computing device for execution, wherein the fingerprinted customer journey will only execute correctly on one or more target computing device.

27. A non-transitory computer readable medium storing instructions which, when executed by one or more computing devices, cause the one or more computing devices to perform a method of offline tampering a machine learning pipeline component, wherein the one or more computing devices perform the method including: evolving a unique initial key value assigned to a set of parameters and/or hyperparameters of a first component of the machine learning pipeline, said components executing an integrity check and using a one-way function that produces a new key value within a chosen mathematical subgroup, such that the new key value will stay within the subgroup unless tampering to the set of parameters and/or hyperparameters of the first component of the machine learning pipeline occurs; regulating behavior of the set of parameters and/or hyperparameters of a second component of the machine learning pipeline using the new key value, such that the integrity check fails if the evolved new key value is incorrect and the second component of the machine learning pipeline not functioning correctly.

28. A non-transitory computer readable medium storing instructions such as embodiment 12 where parameters are global, local, categorical, longitudinal, continuous.

29. A non-transitory computer readable medium storing instructions which, when executed by one or more computing devices, cause the one or more computing devices to perform a method of protecting machine learning pipeline components, wherein the one or more computing devices perform the method including: receiving a customer journey at a first stage of a machine learning pipeline; receiving stage configuration information from a second stage of a machine learning at the first stage of a machine learning pipeline; generating a model output journey at the first stage of a machine learning pipeline for the customer journey, wherein the model output journey is generated based, at least in part, on the stage configuration information from second stage; determining a starting point within the model output journey at the first stage of a machine learning pipeline; transmitting the starting point from the first stage of a machine learning pipeline to a second stage of a machine learning pipeline; generating a long secret key based on the model output journey at the first stage of a machine learning pipeline; and generating a perfectly secret encryption key based on the long secret key at the first stage of a machine learning pipeline.

30. A non-transitory computer readable medium storing instructions which, when executed by one or more computing devices, cause the one or more computing devices to perform a method of protecting machine learning pipeline components, wherein the one or more computing devices to perform a method of protecting machine learning pipeline components, wherein the one or more computing devices generate a secret key from joint randomness shared by a data processing stage of a machine learning pipeline and a modeling stage of a machine learning pipeline, the method comprising: based on the modeling stage of a machine learning second stage of a machine learning pipeline, generating a journey response vector based on a channel between said data processing stage and said modeling stage; said modeling stage receiving a syndrome from said data processing stage, wherein the syndrome has been generated by said data processing stage from a first set of bits generated from a first sampled journey based on the feature engineering generated between said data processing stage and said modeling stage; said modeling stage generating the second set of bits from the syndrome received from said data processing stage and the journey response vector; and the modeling stage generating the secret key from the second set of bits.

31. A non-transitory computer readable medium storing instructions which, when executed by one or more computing devices, cause the one or more computing devices to perform a method of protecting machine learning pipeline components, wherein the one or more computing devices to perform a method of protecting machine learning pipeline components, the method comprising: receiving, by at least one computing device, a data stream comprising a plurality of data points; comparing, by the at least one computing device, individual data patterns of the plurality of data points with a decision boundary to determine whether the individual data patterns are outside the decision boundary, the decision boundary corresponding to at least one classification model formed using training data; and recording individual data patterns into a log.

32. A non-transitory computer readable medium storing instructions which, when executed by one or more computing devices, cause the one or more computing devices to perform a method of protecting machine learning pipeline components, wherein the one or more computing devices to perform a method of protecting machine learning pipeline components, the method comprising: receiving, by at least one computing device, a data stream comprising a plurality of data points; comparing, by the at least one computing device, individual data patterns of the plurality of data points with a decision boundary to determine whether the individual data patterns are outside the decision boundary, the decision boundary corresponding to at least one classification model formed using training data; and changing, upon detection of being outside the decision boundary, the execution steps of one or more of the pipeline components.

What is claimed is:

1. A tangible, non-transitory, machine-readable medium storing instructions that, when executed by one or more processors, effectuate operations comprising:
obtaining, with a computer system, code and data implementing a machine-learning model;
modifying, with the computer system, the code or data implementing the machine-learning model to make the code and data implementing the machine-learning model more difficult to reverse engineer by probing the machine-learning model with input data; and
storing, with the computer system, the modified code and data implementing the machine-learning model in memory.

2. The medium of claim 1, wherein the machine-learning model is part of a machine-learning pipeline, the code is part of object code of the machine-learning pipeline, and modifying comprises:
matching a first object code sequence to a second object code sequence in the code in response to classifying a first task of the first object code sequence as being similar to a second task of the second object code sequence;
modifying the object code of the machine learning pipeline by:
inserting a third object code sequence into the object code of the machine learning pipeline, the third code sequence comprising one or more instructions, and being operable to pass control to the first object code sequence;
inserting a branch at an end of the first object code sequence, the branch being operable to:
pass control, upon detection of a first predefined condition, to an instruction following the first object code sequence, and to pass control, upon detection of a second predefined condition, to an instruction following the third object code sequence; and
wherein:
the third code sequence is configured to be executed in place of the second object sequence without affecting completion of the first task or the second task, or
the third code sequence is configured to be executed ahead of the second object sequence without affecting completion of the first task or the second task.

3. The medium of claim 2, wherein the third code sequence is configured to be executed in place of the second object sequence without affecting completion of the first task or the second task.

4. The medium of claim 2, wherein the third code sequence is configured to be executed ahead of the second object sequence without affecting completion of the first task or the second task.

5. The medium of claim 2, wherein modifying the object code of the machine-learning pipeline comprises modifying a feature engineering stage of the machine-learning pipeline.

6. The medium of claim 5, the object code of the machine-learning pipeline is obtained by interpreting a source code representation of the feature engineering stage to obtain the object code of the machine-learning pipeline.

7. The medium of claim 6, wherein the first, the second, and the third object code sequences perform at least one of the following when executed:
injection affinity score,
inject propensity score,
compose target,
extract statistical parameters,
set parameters, explore parameters,
enrich data,
aggregate on one or more time dimensions,
aggregate on one or more spatial dimensions,
select features based on correlation,
create lag based features,
encode stationarity,
encode seasonality,
encode cyclicity,
impute over range of dimension,
regress,
create a stream,
publish a stream,
subscribe to a stream,
update a record,
connect to a source,
perform source to target mapping,
connect to a sink,
select a record,
use deep learning to extract new features,
leverage parameters from boosted gradient search,
synthesis through generative adversarial networks,
encode,
morph outliers,
bins,
nonlinear transform,
group,
feature split,
decimate,
up sample,
down sample,
extract reliability, and
changes attributes.

8. The medium of claim 2, wherein modifying comprises obfuscating stages of the machine-learning pipeline.

9. The medium of claim 1, wherein modifying comprises:
selecting a sequence of source to target mapping statements, the sequence of source to target mapping statements having a predefined order;
incorporating at least a first concurrent process and a second concurrent process into a computer program by which at least part of the machine-learning model is implemented;
incorporating a first source to target mapping statement from the sequence into the first concurrent process;
incorporating a second source to target mapping statement from the sequence into the second concurrent process;
introducing a plurality of guard variables to control the execution of the at least one of the first concurrent process or the second concurrent process;
causing execution of the first concurrent process and the second concurrent process such that the sequence of source to target mapping statements is executed in the predefined order; and
assigning an error value to at least one of the plurality of guard variables without causing incorrect execution of the sequence of source to target mapping statements.

10. The medium of claim 9, wherein modifying comprises obfuscating a data processing stage of a machine learning pipeline including the machine-learning model.

11. The medium of claim 9, wherein the machine-learning model is part of a machine-learning pipeline, the code is part of object code of the machine-learning pipeline, and modifying comprises:
matching a first object code sequence to a second object code sequence in the code in response to classifying a first task of the first object code sequence as being similar to a second task of the second object code sequence;
modifying the object code of the machine learning pipeline by:
inserting a third object code sequence into the object code of the machine learning pipeline, the third code sequence comprising one or more instructions, and being operable to pass control to the first object code sequence;
inserting a branch at an end of the first code sequence, the branch being operable to:
pass control, upon detection of a first predefined condition, to an instruction following the first object code sequence, and to pass control, upon detection of a second predefined condition, to an instruction following the third object code sequence; and
wherein:
the third code sequence is configured to be executed in place of the second object sequence without affecting completion of the first task or the second task, or
the third code sequence is configured to be executed ahead of the second object sequence without affecting completion of the first task or the second task.

12. The medium of claim 1, wherein modifying comprises:
selecting a watermark integer;
choosing a watermark journey template corresponding to the selected watermark integer from a class of watermark journey templates having at least one property, the at least one property being an enumeration such that each member watermark journey template of the class of watermark journey template is associated with a respective integer value;
creating a watermark-generated journey piece with generated events and features of the watermark journey template; and
creating a watermarked customer journey by modifying a customer journey among the data by embedding the watermark-generated journey piece with the customer journey such that the watermark-generated journey piece becomes present and detectable in further processing of the watermarked customer journey.

13. The medium of claim 12, wherein the watermark-generated journey piece is detectable in further processing using substantially all events and features modified by a machine-learning pipeline including the machine-learning model.

14. The medium of claim 1, wherein modifying comprises:
selecting a fingerprint integer;
selecting a fingerprint template corresponding to the selected watermark integer from a class of fingerprint template having at least one property, the at least one property being an enumeration such that each member fingerprint template of the class of fingerprint template is associated with a respective integer value;
creating a fingerprint journey piece with generated events and features of watermark journey template;
creating a fingerprinted customer journey by modifying a customer journey among the data by embedding the fingerprint journey piece with the customer journey; and
providing the fingerprinted customer journey to a one or more target computing devices for execution.

15. The medium of claim 14, wherein the fingerprinted customer journey will only execute correctly on a specified set of target computing devices and will not execute correctly on other computing devices.

16. The medium of claim 1, wherein modifying comprises:
evolving a unique initial key value assigned to a set of parameters and hyperparameters of a first component of a machine-learning pipeline including the machine-learning model, wherein the unique initial key is evolved with components of the machine-learning pipeline executing an integrity check and using a one-way function that produces a new key value within a chosen mathematical subgroup, such that the new key value will stay within the subgroup unless tampering to the set of parameters and hyperparameters of the first component of the machine learning pipeline occurs; and
regulating behavior of the set of parameters and hyperparameters of a second component of the machine learning pipeline using the new key value, such that an integrity check fails if the evolved new key value is incorrect.

17. The medium of claim 16, wherein the second component of the machine learning pipeline is not functioning correctly.

18. The medium of claim 16, wherein parameters are global, local, categorical, longitudinal, or continuous.

19. The medium of claim 1, wherein modifying comprises:
receiving a customer journey at a first stage of a machine-learning pipeline including the machine-learning model;
receiving stage configuration information from a second stage of the machine-learning pipeline;
generating a model output journey at the first stage of a machine-learning pipeline for the customer journey, wherein the model output journey is generated based, at least in part, on the stage configuration information from second stage;
determining a starting point within the model output journey at the first stage of the machine learning pipeline;
transmitting the starting point from the first stage of the machine learning pipeline to the second stage of the machine learning pipeline;
generating a secret key based on the model output journey at the first stage of the machine learning pipeline; and
generating a perfectly secret encryption key based on the secret key at the first stage of the machine learning pipeline.

20. The medium of claim 1, wherein modifying comprises protecting machine-learning pipeline components including the machine-learning model by generating a secret key from joint randomness shared by a data processing stage of the machine-learning pipeline and a modeling stage of the machine-learning pipeline.

21. The medium of claim 20, wherein generating comprises:
generating, with the modeling stage of the machine-learning pipeline, a journey response vector based on information from a channel between the data processing stage and the modeling stage;
receiving, with the modeling stage, a syndrome from the data processing stage, wherein the syndrome is generated by the data processing stage from a first set of bits generated from a first sampled journey based on feature engineering generated between the data processing stage and the modeling stage;
generating, with the modeling stage, the second set of bits from the syndrome received from the data processing stage and the journey response vector; and
generating, with the modeling stage, the secret key from the second set of bits.

22. The medium of claim 20, wherein the generating comprises:
receiving, by at least one computing device, a data stream comprising a plurality of data points;
comparing, by the at least one computing device, individual data patterns of the plurality of data points with a decision boundary to determine whether the individual data patterns are outside the decision boundary, the decision boundary corresponding to at least one classification model formed using training data; and
recording individual data patterns into a log.

23. The medium of claim 20, wherein the generating comprises:
receiving, by at least one computing device, a data stream comprising a plurality of data points;
comparing, by the at least one computing device, individual data patterns of the plurality of data points with a decision boundary to determine whether the individual data patterns are outside the decision boundary, the decision boundary corresponding to at least one classification model formed using training data; and
changing, upon detection of being outside the decision boundary, the execution steps of one or more of the pipeline components.

24. The medium of claim 1, wherein:
the machine-learning model is part of a machine-learning pipeline, the code is part of object code of the machine-learning pipeline, and modifying comprises:
matching a first object code sequence to a second object code sequence in the code in response to classifying a first task of the first object code sequence as being similar to a second task of the second object code sequence;
modifying the object code of the machine learning pipeline by:
inserting a third object code sequence into the object code of the machine learning pipeline, the third code sequence comprising one or more instructions, and being operable to pass control to the first object code sequence;
inserting a branch at an end of the first object code sequence, the branch being operable to:
pass control, upon detection of a first predefined condition, to an instruction following the first object code sequence, and to pass control, upon detection of a second predefined condition, to an instruction following the third object code sequence; and
wherein:
the third code sequence is configured to be executed in place of the second object sequence without affecting completion of the first task or the second task, or
the third code sequence is configured to be executed ahead of the second object sequence without affecting completion of the first task or the second task;
the code is part of object code of the machine-learning pipeline, and modifying comprises:
matching a first object code sequence to a second object code sequence in the code in response to classifying a first task of the first object code sequence as being similar to a second task of the second object code sequence;
modifying the object code of the machine learning pipeline by:
inserting a third object code sequence into the object code of the machine learning pipeline, the third code sequence comprising one or more instructions, and being operable to pass control to the first object code sequence;
inserting a branch at an end of the first code sequence, the branch being operable to:
pass control, upon detection of a first predefined condition, to an instruction following the first object code sequence, and to pass control, upon detection of a second predefined condition, to an instruction following the third object code sequence; and
wherein:
the third code sequence is configured to be executed in place of the second object sequence without affecting completion of the first task or the second task, or
the third code sequence is configured to be executed ahead of the second object sequence without affecting completion of the first task or the second task;
modifying comprises:
selecting a watermark integer;
choosing a watermark journey template corresponding to the selected watermark integer from a class of watermark journey templates having at least one property, the at least one property being an enumeration such that each member watermark journey template of the class of watermark journey template is associated with a respective integer value;
creating a watermark-generated journey piece with generated events and features of the watermark journey template; and
creating a watermarked customer journey by modifying a first customer journey among the data by embedding the watermark-generated journey piece with the first customer journey such that the watermark-generated journey piece becomes present and detectable in further processing of the watermarked customer journey;
modifying comprises:
selecting a fingerprint integer;
selecting a fingerprint template corresponding to the selected watermark integer from a class of fingerprint template having at least one property, the at least one property being an enumeration such that each member fingerprint template of the class of fingerprint template is associated with a respective integer value;
creating a fingerprint journey piece with generated events and features of watermark journey template;
creating a fingerprinted customer journey by modifying a second customer journey among the data by embedding the fingerprint journey piece with the second customer journey; and
providing the fingerprinted customer journey to a one or more target computing devices for execution;
modifying comprises:
evolving a unique initial key value assigned to a set of parameters and hyperparameters of a first component of a machine-learning pipeline including the machine-learning model, wherein the unique initial key is evolved with components of the machine-learning pipeline executing an integrity check and using a one-way function that produces a new key value within a chosen mathematical subgroup, such that the new key value will stay within the subgroup unless tampering to the set of parameters and hyperparameters of the first component of the machine learning pipeline occurs; and
regulating behavior of the set of parameters and hyperparameters of a second component of the machine learning pipeline using the new key value, such that an integrity check fails if the evolved new key value is incorrect;
modifying comprises:
receiving a customer journey at a first stage of a machine-learning pipeline including the machine-learning model;
receiving stage configuration information from a second stage of the machine-learning pipeline;
generating a model output journey at the first stage of a machine-learning pipeline for the customer journey, wherein the model output journey is generated based, at least in part, on the stage configuration information from second stage;
determining a starting point within the model output journey at the first stage of the machine learning pipeline;
transmitting the starting point from the first stage of the machine learning pipeline to the second stage of the machine learning pipeline;
generating a secret key based on the model output journey at the first stage of the machine learning pipeline; and
generating a perfectly secret encryption key based on the secret key at the first stage of the machine learning pipeline; and
modifying comprises protecting machine-learning pipeline components including the machine-learning model by generating a secret key from joint randomness shared by a data processing stage of the machine-learning pipeline and a modeling stage of the machine-learning pipeline
